(19) United States
(12) Patent Application Publication
(10) Pub. No.: US 2006/0094488 A1
(43) Pub. Date: May 4, 2006

(54) System for automatically scheduling events

(76) Inventor: Daniel R. Smith, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 11/250,056

(22) Filed: Oct. 13, 2005

Related U.S. Application Data
(60) Provisional application No. 60/622,031, filed on Oct. 26, 2004.

(51) Int. Cl. A63F 13/00

(52) U.S. Cl. 463/1

(57) ABSTRACT

A method for automatically scheduling events by determining a condition (date, time, team pairing, location preference, meeting sequence, ranking, etc.) is associated with a first participant. Based on the condition, a schedule that includes the first participant is automatically determined.

### CROSS-REFERENCE TO RELATED APPLICATION

This application claims benefit of priority to U.S. Provisional Application Ser. No. 60/662,031, filed on Oct. 26, 2004 by Daniel R. Smith, entitled “SYSTEM FOR AUTOMATICALLY SCHEDULING EVENTS,” and is incorporated by reference herein in its entirety.

TABLE OF CONTENTS

| | PAGE |
|---|---|
| INTRODUCTION AND OUTLINE | 1-2 |
| PRIMARY/SECONDARY LOGIC | 3-11 |
| Rules and Logic | 3 |
| Manual Examples | 4-7 |
| Code Generated Examples | 8-11 |
| INTRO OF OUR EXAMPLE | 12-14 |
| MISCELLANEOUS DATA | 15 |
| CREATING SECONDARY TEMPLATE | 16-34 |
| Unique/Duplicate Method | 16-18 |
| Gain/Lose Method | 18-20 |
| Examples | 21-28 |
| SECONDARY TEMPLATE FOR OUR EXAMPLE | 29-34 |
| CROSSOVER GAME LOGIC | 35-46 |
| SCHEDULING START | 47-77 |
| Bye Logic | 55-66 |
| Scheduling Template | 67-74 |
| Balancing | 75-77 |
| THINGS TO WORK OUT | 78-79 |
| MISCELLANEOUS ITEMS NOT USED | >80 |

### Introduction/Outline

Objective: Create a software scheduling program that will start with the number of teams in given brackets, a number of brackets grouped together in a “league group” (LG), and output a table (database) of games (date, [symbol] , field, home team, guest team, etc.). LG's are defined as leagues that will share common time slots. For now, multiple fields, single location can be presumed, multiple sessions in a calendar year (Session one goes January 15 to March 27; Session 2 March 28^{th} to June 5^{th}, etc.). This last item probably not be a factor. The code should be able to handle the following parameters/considerations:
1) First games for some teams have been manually set up/scheduled. This will almost always be first games, but may be anywhere in the schedule. EX: Team 3 wants to play Friday June 10 at 6:30 so they can have a surprise party after game for teammate (assign team 3 to play team 5 that day and time).
2) Primary and secondary days of play. Example: Team 3 in LG 2 needs to play all Saturday games, when primary night of play for the LG is Friday.
3) Crossover games to other leagues within the LG.
4) “Standard” scheduling requests: Bye on a given week, before one time or after another time on a particular week (either block or establish times)
5) Balance early/late games for all teams in the LG.
6) Tournament format at the end of a regular session for some leagues, not all.
7) Assign game times from either a list of actual times, from a start time and duration of contest, or from a table cross referencing length of game to age (U 10's play 40 min., U14's play 55 min., etc.)
8) Balance home and away games. Duplicate games should be one home and one away per team.
9) Avoid conflicts, two teams, one coach, two different fields, overlapping times.
10) Various intervals between events (games per cycle) (one per day, one per week, one per month). I think this will be automatic, no special considerations.

example, a given league group (LG) may be comprised of: League1, 5 teams; League2, six teams; League3, 6 teams; League4, 7 teams; League5, 8 teams. Overall, 32 teams in 5 leagues form LG1. Team 3 League1, Team 5 in League3, and Team 2 in League4 need all games to be played on secondary night. Various teams have various scheduling requests. Team 2 in League4 and Team 6 in League5 have same coach. League1 and League3 can play crossover games. The software should output a table of games which can then be viewed/printed a number of ways (reports) necessary (obviously, one being five finished league schedules). Maximum capability/limitations: teams ______, ______ leagues??

Outline:

Initial Input:

a) Data enter coaches/customers as in current database.
b) Data enter leagues. With each league, enter number of games to play (not including tournament), enter tournament (YES?NO), Crossover Games (YES?NO and if YES, with which other league), number of games (??)
c) Data enter teams, assign coach from coach/customer list as in current database, assign league group from league group table, with result being teams have been divided into leagues. Team letter is the only specific designation not assigned. Will probably assign team letter and enter games already scheduled once the master template for each league in the LG has been created (see page ______).

From this, code will calculate (count) how many and which teams are in a given league. Not sure of the most efficient way to tell computer which YEAR (2004) session (WINter), age (25Plus), gender (Co-ed), competitive level (A, C, H, N, etc); that is a database design consideration. Everything but the team letter will define the leagues, the leagues will then define the LG. Waiting until templates are created before assigning a team lett will, I believe, allow more flexibility in using multiple scheduling templates (regarding first games being already scheduled). In other [symbol] s, first game is team #00456 verses [symbol] 59, not A verses B, thus pre determining A and B, thus limiting available templates. Not sure if should assign the LG in data entry by league, or have computer prompt user to enter which leagues belong together when start to actual schedule, thus create the LG at that point. I believe this second option is the way to go. Thus, I would think the first scheduling prompts the user would see is “Which leagues will you now be scheduling?” (see below)

Next:
d) Enter leagues that get grouped together (in the LG), based on prompt (from main menu, “begin scheduling”). See “b” above which duplicate “e”, “f”, and “g” below (not sure which is best).
e) Enter number of games to play for each league and if tournament format applies.
f) Enter if crossover games permitted for a given league, if so, against which leagues.* 1 May help in some situations to specify which teams play each other in crossover game.
g) Enter all available time slots and dates possible. If input more time slots than games, need hierarchy of rules to follow (by league group) to determine which are left blank (secondary, end of session, 11:25's after each team has one, Sunday early slots, etc.). If the software is smart enough, if user blocks in enough detail, or if user gives the computer only the exact amount of slots needed, this is a mute point. This will be detailed further in the actual scheduling logic.
h) Enter primary and secondary allocations by team in each league group.

Note:
1) Items “a” through “c” are generic in nature and data needed to set up the teams, leagues and LG's.
2) Items “d” through “h” all apply to league groups and leagues;
3) Item “I” through “k” below apply to individual teams within the leagues.

The last items of input are for individual teams and will be done after templates are created for the LG.
i) Enter first games already scheduled (match up, date, time, field). Again, this will be done after LG's created and all master templates for the leagues in the LG have been created.
j) Assign team letter (only need to make schedules easier to read).
k) Input (or block, which is reverse of input) individual team general team requests. Team 4 needs a bye this week, needs to play >2:00 this week, etc. I may want to do this (as well as “I” and “j”) early on in order to disguise my logic. If I do input in the order of my logic, it might make it easier for someone to try to copy.

### Primary/Secondary Logic and Matrix

The first logic that must be performed regards the primary and secondary nights of play. It is helpful to have some knowledge of scheduling to save some time, but the same code will work either way. In other words, if [symbol] just do hit or miss on input, computer will simply give you an error message: “This combo of input of primary and secondary allocations will not work, try this . . . ”; eventually leading the user to a working solution (see next few pages).

Primary and secondary logic is based on input of primary and secondary games for each team based on customer preference and maximizing facility scheduling. If there are no secondary time slots input for a given league, (arrive at that conclusion if only one set of time slots is given when data input times), we obviously skip this step and code should not prompt entry of primary/secondary allocations.

The goal is of the logic at this point is:
1) To check for accuracy (will it work logically) of total primary/secondary slots within each league.
2) Total secondary/primary games for all leagues in a LG, then cross reference with total slots available, and make sure it will work logically.
3) Create the start of the final schedule template. The end result being match ups of secondary games are created by this logic, which will end up driving the master template.

The following are examples of leagues with various combinations of primary/secondary days or games input for each team. The logic (rules) is as follows:
1) Start with the team (T1) that has the highest number of secondary days and match it up with the team (T2) that has the next highest. If there are two teams that qualify for T2, the logic used is to pick the team that started with the lowest initial number of secondary games; if equal, can be arbitrary or pick the team that is different from the most recent match up.
2) Subtract one secondary game from the two teams selected.
3) Continue this pattern, not voiding or breaking the MAPR rule. Remember, there is no order or dates at this point, only match ups.
4) At some point, there will be one or more teams that qualify for T1 (team with most secondary games remaining). Select the T1 whose initial secondary number was the highest.
5) Again, if the T2 selection involves two teams with identical numbers, see rule #1.

The first result will be a logical combination of primary and secondary games (and subsequent actual match ups) that work. The meaning of “work” is again, customer preference or maximizing facility availability. See the examples and explanations on the following pages. The examples are meant only to explain the logic, with the end result being primary and secondary game input for each team within the league that work logically, creating match ups at the same time. To outline the next few steps: 1) create a primary/secondary working template; 2) use that template to create the master template for the leagues within the LG; 3) integrate or enter already scheduled games into the master template; 4) enter individual team requests; and 5) we are ready to schedule.

Pages 4-7 are manually created matrixes (and match ups); pages 8-11 are actual working matrixes (match ups) derived from code. Again, they are created from functional already written code (in VB).

| League1A: | | PRI | SEC | 9 | 8 | 7 | 6 | 5 | 4 | 3 | 2 | 1 |
|---|---|---|---|---|---|---|---|---|---|---|---|---|
| | A | 6 | 3 | | | | | | | D | D | B |
| MAPR = 2 | B | 3 | 6 | | | | D | D | C | A | C | |
| | C | 4 | 5 | | | | | D | D | B | B | |
| | D | 0 | 9 | B | B | C | C | A | A | F | E | F |
| | E | 8 | 1 | | | | | | | | | D |
| | F | 7 | 2 | | | | | | | | D | D |
| TOTALS: | 6 | 28 | 26 | | | | | | | | | |

From this input, B and C are not able to meet the input criteria: Error message [symbol]
“You have entered an impossible combination of secondary data. Try the follo [symbol]
fewer secondary games for B and C or additional for A, E, or F”. SEE BELOW

[symbol]

| League1B: | | PRI | SEC | 9 | 8 | 7 | 6 | 5 | 4 | 3 | 2 | 1 |
|---|---|---|---|---|---|---|---|---|---|---|---|---|
| | A | 6 | 3 | | | | | | | D | D | B |
| MAPR = 2 | B | 4 | 5 | | | | | D | D | C | A | C |
| | C | 5 | 4 | | | | | | D | D | B | B |
| | D | 0 | 9 | B | C | B | A | C | A | F | E | F |
| | E | 8 | 1 | | | | | | | | | D |
| | F | 7 | 2 | | | | | | | | D | D |
| TOTALS: | 6 | 30 | 24 | | | | | | | | | |
| | | | | DvB | DvC | DvB | DvA | DvC | DvA | DvF | DvE | DvF |
| | | | | | | | | | | BvC | BvA | BvC |

This now works; the matchups created are shown.

| League2A: | | PRI | SEC | 9 | 8 | 7 | 6 | 5 | 4 | 3 | 2 | 1 |
|---|---|---|---|---|---|---|---|---|---|---|---|---|
| | A | 6 | 3 | | | | | | | D | D | C |
| MAPR = 2 | B | 6 | 3 | | | | | | | D | D | C |
| | C | 4 | 5 | | | | | D | D | A | B | |
| | D | 0 | 9 | C | C | A | B | F | A | B | E | F |
| | E | 8 | 1 | | | | | | | | | D |
| | F | 7 | 2 | | | | | | | | D | D |
| TOTALS: | 6 | 31 | 23 | | | | | | | | | |

From this input, C not able to meet criteria. Also, sec and prim game
totals are odd number (won't work unless crossovers). Move one secondary
game for C to primary.

| League2B: | | PRI | SEC | 9 | 8 | 7 | 6 | 5 | 4 | 3 | 2 | 1 |
|---|---|---|---|---|---|---|---|---|---|---|---|---|
| | A | 6 | 3 | | | | | | | D | D | C |
| MAPR = 2 | B | 6 | 3 | | | | | | | D | D | C |
| | C | 5 | 4 | | | | | | D | D | A | B |
| | D | 0 | 9 | C | A | B | C | F | A | B | E | F |
| | E | 8 | 1 | | | | | | | | | D |
| | F | 7 | 2 | | | | | | | | D | D |
| TOTALS: | 6 | 32 | 22 | | | | | | | | | |
| WEEK: | | | | 1 | 2 | 3 | 4 | 5 | 6 | 7 | 8 | 9 |
| | | | | DvC | DvA | DvB | DvC | DvF | DvA | DvB | DvE | DvF |
| | | | | | CvA | | | | | | CvB | |

This now works logically and establishes the matchups shown
(not chronilogical, just groupings):

| League4C: | | PRI | SEC | 9 | 8 | 7 | 6 | 5 | 4 | 3 | 2 | 1 |
|---|---|---|---|---|---|---|---|---|---|---|---|---|
| | A | 0 | 9 | B | D | F | C | E | G | B | D | F |
| MAPR = 2 | B | 7 | 2 | | | | | | | | A | A |
| | C | 7 | 1 | | | | | | | | | A |
| | D | 7 | 2 | | | | | | | | A | A |
| | E | 8 | 1 | | | | | | | | | A |
| | F | 7 | 2 | | | | | | | | A | A |
| | G | 8 | 1 | | | | | | | | | A |
| TOTALS: | 7 | 44 | 18 | | | | | | | | | |

This now works, but C = 8 games

| League4D: | | PRI | SEC | 10 | 9 | 8 | 7 | 6 | 5 | 4 | 3 | 2 | 1 |
|---|---|---|---|---|---|---|---|---|---|---|---|---|---|
| | A | 0 | 9 | | B | C | D | E | F | G | B | C | D |
| MAPR = 2 | B | 7 | 2 | | | | | | | | | A | A |
| | C | 7 | 2 | | | | | | | | | A | A |
| | D | 7 | 2 | | | | | | | | | A | A |
| | E | 8 | 2 | | | | | | | | | A | F |
| | F | 7 | 2 | | | | | | | | | A | E |
| | G | 8 | 1 | | | | | | | | | | A |
| TOTALS: | 7 | 44 | 20 | | AvB | AvC | AvD | AvE | AvF | AvG | AvB | AvC | AvD |
| | | | | | | | | | | | | | EvF |

This now works, E has extra game (this is transferred to our LG, league2, 3

| League5A: | | PRI | SEC | 9 | 8 | 7 | 6 | 5 | 4 | 3 | 2 | 1 |
|---|---|---|---|---|---|---|---|---|---|---|---|---|
| | A | 0 | 9 | B | C | D | E | F | G | H | B | C |
| MPR = 2 | B | 7 | 2 | | | | | | | | A | A |
| | C | 7 | 2 | | | | | | | | A | A |
| | D | 8 | 1 | | | | | | | | | A |
| | E | 8 | 1 | | | | | | | | | A |
| | F | 8 | 1 | | | | | | | | | A |
| | G | 8 | 1 | | | | | | | | | A |
| | H | 8 | 1 | | | | | | | | | A |
| TOTALS: | 8 | 54 | 18 | AvB | AvC | AvD | AvE | AvF | AvG | AvH | AvB | AvC |

This works (this is transferred to league group, 35PCN)

| League6A: | | PRI | SEC | 8 | 7 | 6 | 5 | 4 | 3 | 2 | 1 |
|---|---|---|---|---|---|---|---|---|---|---|---|
| | A | 0 | 8 | B | F | C | E | G | B | D | F |
| MAPR = 2 | B | 6 | 2 | | | | | | | A | A |
| | C | 6 | 2 | | | | | | | | A |
| | D | 6 | 2 | | | | | | | A | A |
| | E | 6 | 2 | | | | | | | | A |
| | F | 6 | 2 | | | | | | | A | A |
| TOTALS: | 6 | 30 | 18 | | | | | | | | A |
| | | | | AvB | AvC | AvD | AVE | AvF | AvB | AvC | AvD |
| | | | | | | | | | | | EvF |

This works (this is transferred to league group, 25PCC)
Now, back to our example, with final [symbol] and matchups:

| League1: | | PRI | SEC | 8 | 7 | 6 | 5 | 4 | 3 | 2 | 1 | | |
|---|---|---|---|---|---|---|---|---|---|---|---|---|---|
| (25PCC) | A | 0 | 8 | B | C | D | E | F | B | C | D | | |
| | B | 6 | 2 | | | | | | | A | A | | |
| | C | 6 | 2 | | | | | | | A | A | | |
| MAPR = 2 | D | 6 | 2 | | | | | | | A | A | | |
| | E | 6 | 2 | | | | | | | A | F | | |
| | F | 6 | 2 | | | | | | | A | E | | |
| TOTALS: | 6 | 30 | 18 | | | | | | | | | | |
| | | | | AvB | AvC | AvD | AVE | AvF | AvB | AvC | AvD | | |
| | | | | | | | | | | | EvF | | |
| League2: | | PRI | SEC | 10 | 9 | 8 | 7 | 6 | 5 | 4 | 3 | 2 | 1 |
| (35PCC) | A | 0 | 9 | | B | C | D | E | F | G | B | C | D |
| | B | 7 | 2 | | | | | | | | | A | A |
| | C | 7 | 2 | | | | | | | | | A | A |
| | D | 7 | 2 | | | | | | | | | A | A |
| MAPR = 2 | E | 8 | 2 | | | | | | | | | A | F |
| | F | 7 | 2 | | | | | | | | | A | E |
| | G | 8 | 1 | | | | | | | | | | A |
| TOTALS: | 7 | 44 | 20 | | | | | | | | | | |
| | | | | | AvB | AvC | AvD | AVE | AvF | AvG | AvB | AvC | AvD |
| | | | | | | | | | | FvE | | | |
| League3: | | PRI | SEC | 9 | 8 | 7 | 6 | 5 | 4 | 3 | 2 | 1 | |
| (35PCN) | A | 0 | 9 | B | C | D | E | F | G | H | B | C | |
| | B | 7 | 2 | | | | | | | | A | A | |
| | C | 7 | 2 | | | | | | | | A | A | |
| | D | 8 | 1 | | | | | | | | | A | |
| MAPR = 2 | E | 8 | 1 | | | | | | | | | A | |
| | F | 8 | 1 | | | | | | | | | A | |
| | G | 8 | 1 | | | | | | | | | A | |
| | H | 8 | 1 | | | | | | | | | A | |
| TOTALS: | 8 | 54 | 18 | | | | | | | | | | |
| | | | | AvB | AvC | AvD | AVE | AvF | AvG | AvH | AvB | AvC | |

THE ABOVE THREE LEAGUES COMPRISE THE LG FOR OUR EXAMPLE AND ARE LABELED
MASTER EXAMPLE 1A.

Referencing our outline steps “a”-“k”, we have completed “a”-“h”. This (along with user data input) results in the following LG that we will use periodically throughout this manual. Note, with L2, the logic of “requiring” Team E playing a 10^{th} game was through this process.

MASTER EXAMPLE 1A

| | | |
|---|---|---|
| INPUT/PROMPT: | Which leagues do you wish to schedule” | ANSWER: 25PCC, 35PCC, 35PCN |
| | Any games already scheduled? | ANSWER: YES/NO IF YES, |

| INPUT/PROMPT: | | Please input time slots available: | | See Example 3. |
|---|---|---|---|---|
| | | | | Avail Slots |
| | ANSWER: | Primary: | Fridays, 9 weeks, 6:15-11:25 (7 games) | 63 |

| | | | |
|---|---|---|---|
| Secondary | Saturdays, 6 weeks, 6:00-8:40 (4 games) | 24 | Total Sec = 32 |

| | |
|---|---|
| Saturdays, 2 weeks, 7:50-10:30 (4 games) | 8 |

| | | |
|---|---|---|
| TOTAL: | 95 | Total avail |

| | | |
|---|---|---|
| Teams LG1 (25PCC) by count: | 6 | slots |

| Number games per session | 8 | INPUT now or earlier with league | |
|---|---|---|---|
| Tourney: | YES | Ditto | See Example 2 for handling tourney |

| Crossover Games: | | NO | Ditto | TEAM | PRI*1 | SEC*1 | GAMES |
|---|---|---|---|---|---|---|---|
| CODE CALCULATES: | | | | 1 | 0 | 8 | 8 |
| Total Num games: | 24 | 24 | *1 | 2 | 6 | 2 | 8 |
| Unique Games | 15 | | | 3 | 6 | 2 | 8 |
| Dup Games | 9 | | | 4 | 6 | 2 | 8 |
| Primary Games | 15 | | | 5 | 6 | 2 | 8 |
| Secondary games | 9 | | | 6 | 6 | 2 | 8 |

| | | | | | | |
|---|---|---|---|---|---|---|
| NTPD* | 3 | TOTALS | 6 | 30 | 18 | 48 |
| MAPR* | 2 | | | | | |
| MIPR* | 1 | | | | | |

| Teams LG2 (35PCC) by count: | | 7 | | | | | |
|---|---|---|---|---|---|---|---|
| Number games per session | | 9 | INPUT now or earlier with league | | | | |
| Tourney: | | NO | Ditto | TEAM | PRI | SEC | GAMES |
| Crossover Games: | | YES | With 35PCN | 1 | 0 | 9 | 9 |
| CODE CALCULATES: | | | Will not actual do in | 2 | 7 | 2 | 9 |
| Total Num games: | 32 | | crossover in our | 3 | 7 | 2 | 9 |
| Unique Games | 21 | | example, but do | 4 | 7 | 2 | 9 |
| Dup Games | 11 | | separtely. | 5 | 8 | 2 | 10 |
| Primary Games | 22 | | | 6 | 7 | 2 | 9 |
| Secondary games | 10 | | | 7 | 8 | 1 | 9 |

| | | | | | | |
|---|---|---|---|---|---|---|
| NTPD* | 3 | TOTALS | 7 | 44 | 20 | 64 |
| MAPR* | 2 | | | | | |
| MIPR* | 1 | | | | | |

| Teams League3 (35PCN): | 8 | | | | | |
|---|---|---|---|---|---|---|
| Number games per session | 9 | INPUT now or earlier with league | | | | |
| Tourney: | NO | Ditto | TEAM | PRI | SEC | GAMES |
| Crossover Games: | YES | With 35PCC | 1 | 0 | 9 | 9 |
| CODE CALCULATES: | | | 2 | 7 | 2 | 9 |

| Total Num games: | 36 | | 3 | 7 | 2 | 9 |
|---|---|---|---|---|---|---|
| Unique Games | 29 | | 4 | 8 | 1 | 9 |
| Dup Games | 8 | | 5 | 8 | 1 | 9 |
| Primary Games | 27 | | 6 | 8 | 1 | 9 |
| Secondary games | 9 | | 7 | 8 | 1 | 9 |
| NTPD* | 2 | | 8 | 8 | 1 | 9 |
| MAPR* | 2 | TOTALS | 8 | 54 | 18 | 72 |
| MIPR* | 1 | | | | | |

| | |
|---|---|
| League and LG checks: | GRAND TOTALS: |

| | | |
|---|---|---|
| 1) Team Pri + Sec = Total Games | Total Num games: | 92 |
| 2) Unique + duplicate = Total games | Unique Games | 64 |
| | Dup Games | 28 |
| | Primary Games | 64 |
| | Secondary games | 28 |

NTPD*: Number of opponents that each team will play in duplicate.
MAPR*: Maximum play rule. Number equals maximum times two teams can play one another.
MIPR*: Minimum play rule. Number equals minimum times two teams can play one another (override??)
*1: Two ways to calculate one mathematical, other from primary/secondary (use this).

LG Logic:
1) Check individual league logic to make sure each league OK. Pretty sure this may already be done at the primary/secondary stage and built in at a prior stage stage.
2) Check total slots available (TSA), 95, to total games (TG), 92. We are OK in this example. If not OK, error messages (add more slots, take away games . . . .)
3) Check secondary slots available (SSA), 32, to secondary games (SG), 28. Again OK. If not, appropriate error messages.
4) Compare primary slots available (PSA), 63, to primary games (PG), 64. Problem. Appropriate message: “Need to move primary game(s) to secondary slot. Prompt either user choice to pick league and teams, or let computer do with logical solution being teams 4-8, 35PCN who only have one secondary game. In this example, we assigned D and E, 34PCN, an additional secondary game.
5) We will then have 63 PSA's, 63 primary games and 32 SSA's, 28 secondary games which will leave 4 secondary slots not used. During scheduling we may need to give the code (rules) guidance on how to leave those blank (arbitrary, no more than one per day, the worst time slots, the best time slots, user choice, all at the end of the session, don't leave a blank right in the middle of slots used). The program then needs to let the user know which were not used and, obviously, make them available for other leagues.

The final LG now looks as follows (next page).

We now have the actual secondary match ups (who plays who, but no dates and times) to make primary/secondary allocations work for each league. Now we need to fit those match ups into the master template for that league and each league within the LG. The first step is creating a secondary allocation template and then fitting that into the master. The master template is defined as the unique match ups only for a given league and is “stored”. We have a 4 team template on file, 5 team, 6 team, probably up to 12 teams, but the number probably does not matter, we only need one per league.

MASTER EXAMPLE 1B

| | | |
|---|---|---|
| INPUT/PROMPT: | Which leagues do you wish to schedule” | ANSWER: 25PCC, 35PCC, 35PCN |
| | Any games already scheduled? | ANSWER: YES/NO IF YES, |

| INPUT/PROMPT: | | Please input time slots available: | | See Example 3. | |
|---|---|---|---|---|---|
| | | | | | Avail Slots |
| | ANSWER: | Primary: | Fridays, 9 weeks, 6:15-11:25 (7 games) | 63 | Avail Slots |

| | | |
|---|---|---|
| Secondary | Saturdays, 6 weeks, 6:00-8:40 (4 games) | 24 |
| | Saturdays, 2 weeks, 7:50-10:30 (4 games) | 8 |

| | | |
|---|---|---|
| TOTAL: | 95 | Avail Slots |

| Teams LG1 (25PCC) by count: | 6 | | |
|---|---|---|---|
| Number games per session | 8 | INPUT now or earlier with league | |
| Tourney: | YES | Ditto | See Example 2 for handling tourney |

| | | | | | | |
|---|---|---|---|---|---|---|
| Crossover Games: | NO | Ditto | TEAM | PRI*1 | SEC*1 | GAMES |
| CODE CALCULATES: | | | 1 | 0 | 8 | 8 |

| Total Num games: | 24 | | 2 | 6 | 8 | 8 |
|---|---|---|---|---|---|---|
| Unique Games | 15 | | 3 | 6 | 2 | 8 |
| Dup Games | 9 | | 4 | 6 | 2 | 8 |
| Primary Games | 15 | | 5 | 6 | 2 | 8 |
| Secondary games | 9 | | 6 | 6 | 2 | 8 |
| NTPD | 3 | TOTALS | 6 | 30 | 18 | 48 |
| MAPR | 2 | | | | | |
| MIPR | 1 | | | | | |

| Teams LG2 (35PCC) by count: | 7 | | | | | |
|---|---|---|---|---|---|---|
| Number games per session | 9 | INPUT now or earlier with league | | | | |
| Tourney: | NO | Ditto | TEAM | PRI | SEC | GAMES |
| Crossover Games: | YES | With 35PCN | 1 | 0 | 9 | 9 |
| CODE CALCULATES: | | | 2 | 7 | 2 | 9 |

| | | | | | | |
|---|---|---|---|---|---|---|
| Total Num games: | 32 | | 3 | 7 | 2 | 9 |
| Unique Games | 21 | | 4 | 7 | 2 | 9 |
| Dup Games | 11 | | 5 | 8 | 2 | 10 |
| Primary Games | 22 | | 6 | 7 | 2 | 9 |
| Secondary games | 10 | | 7 | 8 | 1 | 9 |
| NTPD | 3 | TOTALS | 7 | 44 | 20 | 64 |
| MAPR | 2 | | | | | |
| MIPR | 1 | | | | | |

| Teams League3 (35PCN): | 8 | | | | | |
|---|---|---|---|---|---|---|
| Number games per session | 9 | INPUT now or earlier with league | | | | |
| Tourney: | NO | Ditto | TEAM | PRI | SEC | GAMES |
| Crossover Games: | YES | With 35PCC | 1 | 0 | 9 | 9 |
| CODE CALCULATES: | | | 2 | 7 | 2 | 9 |

| Total Num games: | 36 | | 3 | 7 | 2 | 9 |
|---|---|---|---|---|---|---|
| Unique Games | 28 | | 4 | 7 | 2 | 9 |
| Dup Games | 8 | | 5 | 7 | 2 | 9 |
| Primary Games | 26 | | 6 | 8 | 1 | 9 |
| Secondary games | 10 | | 7 | 8 | 1 | 9 |
| NTPD | 2 | | 8 | 8 | 1 | 9 |
| MAPR | 2 | TOTALS | 8 | 52 | 20 | 72 |
| MIPR | 1 | | | | | |

| | |
|---|---|
| League Checks: | GRAND TOTALS: |

| | | |
|---|---|---|
| 1) Team Pri + Sec = Total Games | Total Num games | 92 |
| 2) Total Pri and total Sec must be even number | Unique Games | 64 |
| 3) Pri + Sec and Unique + Dup equals Total | Dup Games | 28 |
| | Primary Games | 63 |
| | Secondary games | 29 |

### Creating the Primary/Secondary Template

The objective here is to turn the primary/secondary match ups previously generated into an actual template of games that can plug into the master template. The overall objective is to evenly balance or spread out the secondary match ups within the master template. As the thought process right now concerning the master template is to pull down from a choice of 5-7 stored matrixes per league (NOTE, I no longer think this is the way to go, but will leave it in as bits and pieces may get used at various places and leads us to the eventual solution), we need the template from the primary/secondary match ups to be as flexible as possible. Basically, we do not want to narrow the choices from the master templates due to the primary/secondary template. There are two ways to do this, the third being a combination of 1 and 2.
1) Break out the primary/secondary match ups into SETS, with each set broken into unique and duplicate match ups (the last SET is the only one that will have duplicate match ups, where duplicate is where we don't care who play who). When we do this, we want to put as many match ups in the duplicate column as possible. This would put the minimum number in the unique column, with the secondary template thus fitting into more of the master templates. As the master template is unique games only with the remainder of duplicate games picked randomly, we would then pick those unique games only created by the primary/secondary template, and the fewer unique games, the more options created. I will call this the Unique/Duplicate method.
2) Create the master template from the primary/secondary template. This looks like the way to, making #1 above not the way to go and reason for NOTE above. I will call this the Gain/Lose method.
3) A combination of 1 and 2 depending on NTPD.

A) UNIQUE/DUPLICATE Method: We will work with some of the previously created primary/secondary matrixes previously created.

Logic
1) Determine the team that has the most secondary match ups (if 2 have the same, pick the one that has the greatest number of unique opponents; if that is identical, flip coin), and break up those games into unique and duplicate match ups. We should have no more columns than we have cycles to complete. Note, cycles to complete will be actual (byes accounted for), not mathematical, though we will work conceptually using the mathematical cycles to complete (9 games, 6 teams, cycles=9). The number of columns on the duplicate side will equal the NTPD. If all match ups are on one side or the other, check for a template match (see EX 2 below).
2) Place any remaining match ups that have no conflicts with duplicate match ups “under” (in same set) those duplicate match ups, obviously on the duplicate side of the ledger. This set of match ups will then be “completed” at a later time with teams not involved in the primary/secondary matrix. As duplicate match ups will be picked arbitrarily at a later time, it does not matter what these match ups are. By placing as many match ups/series in the duplicate column, we free up the unique. If all match ups are on one side or the other, check for a template (s) match (see EX 2 below).
3) Place any other remaining match ups “under” unique match ups with no conflicts; the maximum columns on the unique side has to be (number of cycles) minus the NTPD. Check for a template (s) match (see EX 2 below).
4) If the number of sets of games on the duplicate side is not “full” (less than the NTPD), move the sets of match ups from Step 3 over to the duplicate side. As the number of duplicate sets of match ups equals the NTPD, we can maximize this side of the ledger up to the NTPD, minimizing those on the unique side, increasing the number of master templates we can plug in to. Remember, do not violate the MPR which may happen when complete a given set on the duplicate side. Check for a template (s) match (see EX 2 below).
5) If no room on the duplicate side, not sure if undoing step 4, or leaving as is, will increase the number of master templates available. We will see with examples. Probably want to undo as want secondary match ups spread out, not together.

The examples on the following page starts with our secondary matrix and match ups, unique/duplicate logic follows.

### EXAMPLE 1

| League1: | | PRI | SEC | 9 | 8 | 7 | 6 | 5 | 4 | 3 | 2 | 1 |
|---|---|---|---|---|---|---|---|---|---|---|---|---|
| (25PCC) | A | 0 | 9 | C | B | D | C | F | B | D | E | F |
| | B | 6 | 3 | | | | | | | A | A | C |
| MAPR = 2 | C | 5 | 4 | | | | | | A | A | B | D |
| | D | 6 | 3 | | | | | | | A | A | C |
| NTPD = 4 | E | 8 | 1 | | | | | | | | | A |
| | F | 7 | 2 | | | | | | | | A | A |
| TOTALS: | 6 | 32 | 22 | | | | | | | | | |
| | | | | AvC | AvB | AvD | AvC | AvF | AvB | AvD | AvE | AvF |
| | | | | | | | | | | | CvB | CvD |

Logic Step 1:

| UNIQUE | DUPLICATE |
|---|---|
| AvB, AvC, AvD, AvE, AvF | AvB, AvC, AvD, AvF |

Logic Step 2:

| UNIQUE | DUPLICATE |
|---|---|
| AvB, AvC, AvD, AvE, AvF | AvB, AvC, AvD, AvF (Note, BvC not |
| | under |
| | CvD BvC AvD, two EvF's, MPR) |

DONE, The match ups in the unique column will fit in any master template (pulled from 5-7 in storage).

### EXAMPLE 2

| League2: | | PRI | SEC | 8 | 7 | 6 | 5 | 4 | 3 | 2 | 1 |
|---|---|---|---|---|---|---|---|---|---|---|---|
| (25PCC) | A | 4 | 4 | | | | | B | B | C | D |
| | B | 4 | 4 | | | | | A | A | C | D |
| MAPR = 2 | C | 6 | 2 | | | | | | | B | A |
| | D | 6 | 2 | | | | | | | B | A |
| NTPD = 3 | E | 8 | 0 | | | | | | | | |
| | F | 8 | 0 | | | | | | | | |
| TOTALS: | 6 | 36 | 12 | | | | | AvB | AvB | AvC | BvD |
| | | | | | | | | | | AvD | BvC |

Logic Step 1:

| UNIQUE | DUPLICATE |
|---|---|
| AvB, AvC, AvD, BvC, BvD | AvB |

This is step one, 3 steps to go, but even this fits into the 6 team master template #1 and #5. See page for 6 team templates. At this point we can jump out and go to scheduling. If something in scheduling does not work (because of template (s) configuration), we come back and go to step 2.

Logic Step 2: Nothing slides over

Logic Step 3:

| UNIQUE | DUPLICATE |
|---|---|
| AvB, AvC, AvD, | AvB |
| BvD BvC, | |

This does not fit in any templates from page ______.

Logic Step 4:

| UNIQUE | DUPLICATE |
|---|---|
| AvB, AvC, | AvB AvD, Note, other pair not moved as |
| BvD | BvC, MPR broken with EvF. |

This fits into master templates #3 and #4. If we move AC and BD (not AD and BC) to the duplicate side, the result will fit into templates #2 and #6. Between steps #1 and 4, we have all 6 templates enter the picture. In this case we did not gain any more templates, but different ones ????

### EXAMPLE 3

| League3: | | PRI | SEC | 8 | 7 | 6 | 5 | 4 | 3 | 2 | 1 |
|---|---|---|---|---|---|---|---|---|---|---|---|
| (25PCC) | A | 2 | 6 | | | B | D | C | H | I | F |
| | B | 4 | 4 | | | | | A | D | C | H |
| MAPR = 1 | C | 6 | 2 | | | | | | | A | B |
| | D | 5 | 3 | | | | | | A | B | I |
| NTPD = 0 | E | 8 | 0 | | | | | | | | |
| | F | 7 | 1 | | | | | | | | A |
| | G | 8 | 0 | | | | | | | | |
| | H | 6 | 2 | | | | | | | A | B |
| | I | 6 | 2 | | | | | | | A | D |
| TOTALS: | 9 | 52 | 20 | | | AvB | AvD | AvC | AvH | AvI | AvF |
| | | | | | | | | | BvD | BvC | BvH |
| | | | | | | | | | | | DvI |

Logic Step 1:

| | |
|---|---|
| UNIQUE | DUPLICATE |

AvB, AvD, AvC, AvH, AvI, AvF BvH, DvI BvD,
BvC,

B) GAIN/LOSE METHOD: As can tell, less games, more teams, create fewer options as number of duplicates goes down, in this case to zero. At this point, options slim to none as to fitting into a master template on file, much less more than one. At this point we look at solution number two from the intro, which is to create a master templates from the secondary match ups using any (one single) master template as a starting point (Gain/Lose method). I will say, the combination of primary/secondary games in the matrix is unusual and probably not realistic but we need the logic to work for all cases. A nine team matrix will normally look more like this (and any template works):

| League4: | | PRI | SEC | 8 | 7 | 6 | 5 | 4 | 3 | 2 | 1 |
|---|---|---|---|---|---|---|---|---|---|---|---|
| (25PCC) | A | 0 | 8 | B | C | D | E | F | G | H | I |
| | B | 7 | 1 | | | | | | | | A |
| MAPR = 1 | C | 7 | 1 | | | | | | | | A |
| | D | 7 | 1 | | | | | | | | A |
| NTPD = 0 | E | 7 | 1 | | | | | | | | A |
| | F | 7 | 1 | | | | | | | | A |
| | G | 7 | 1 | | | | | | | | A |
| | H | 7 | 1 | | | | | | | | A |
| | I | 7 | 1 | | | | | | | | A |
| TOTALS: | 9 | 56 | 16 | AvB | AvC | AvD | AvE | AvF | AvH | AvG | AvI |

Anyway, back to our tough one. The following pages are three examples all created from the same difficult and unusual nine team matrix and match ups above using my Gain/Lose method. Three different templates can be created starting from the same secondary games simply in different combinations. The three combinations are found below:

### EXAMPLE A

| | |
|---|---|
| UNIQUE | DUPLICATE |

AvB, AvD, AvC, AvH, AvI, AvF, BvH, BvD, BvC,
DvI

### EXAMPLE B

EXAMPLE B:

| | |
|---|---|
| UNIQUE | DUPLICATE |

AvB, AvD, AvC, AvH, AvI, AvF BvH, BvC, DvI
BvD

### EXAMPLE C

| | |
|---|---|
| UNIQUE | DUPLICATE |

AvB, AvD, AvC, AvH, AvI, AvF BvH, DvI BvD,
BvC,

Logic:
1) Organize all secondary match ups on the unique side of the “ledger” based on the same NPTD calculations prior (in this case NTPD=0). The number of match up columns used is based on the cycles to complete or groups of match ups from the initial input in our example of 9 teams, 8 games, that figure is 9 groups of match ups or nine columns on our sheet. Order them by number of games (All A's games go first, B's second, etc.). When you run out of columns, start grouping games. The order will help when we need to come up with “shuffle rules” in the event the first template does not work in the scheduling end of things.
2) Group the match ups, if possible, such that any two together are found in a single match up pairings already on the master template. Examples A and B were done in this fashion with BvH and Dvl (Ex. B) already found together, and AvF and BvD (Ex. C) already matched up. The thought is this would minimize changes to get to the final template. As you can see, this was indeed the case looking at Example C where we started arbitrarily. Multiple templates would only be needed if the scheduler cannot make the scheduling work (balancing, byes, team requests, etc.) with the one picked out.
3) Again, the goal of the final template is to evenly distribute all the secondary games throughout the series of match ups. In our example, we want one secondary game in 8 series of games, two in the 9^{th} (10 total per input) verses, for example, one in 6, two in 2, none in 1 (10 total). The total is the same but the former will make the eventual scheduling much easier and more efficient.
4) I'm not sure if I can pin down the exact steps or logic, but the overall premise to get from the initial master template (simply in “storage”), to the one we need in step 3, using a sequence of lose/gain match ups simply by changing team letters around. There is probably a mathematical method, or perhaps simply have the code go to town, and keep looping till it accidentally stumbles on the final balanced template. I will try to give some possible guidance and rules to get there quicker.
5) When making changes, do not change the secondary match ups currently in the template that are balanced the way we want.
6) All three examples required a change or flip of teams in the bye column (co-incidence or needed, not sure). In an 8 team league, no bye, so we will try an 8 team example (see next page).
7) You want to start with a group of match ups that has no secondary match ups, creating one that we want to lose in another group.
8) From there, look at the match ups in the gain column, go find the other one (now a duplicate) in another group and do another gain/lose transaction, losing one of the ones we just gained in the prior step, at the same time trying to gain a match up that we just lost in the prior step (or a prior step).
9) Continue this pattern until we have gained everything we lost and lost everything we gained and we have our master template.

SEE FOLLOWING 8 PAGES FOR EXAMPLES A, B, and C. EXAMPLE D (8 Team) IS FOUND BELOW.

EXAMPLE D, 8 TEAMS

| League4: | | PRI | SEC | 8 | 7 | 6 | 5 | 4 | 3 | 2 | 1 |
|---|---|---|---|---|---|---|---|---|---|---|---|
| (25PCC) | A | 2 | 6 | | | B | D | B | C | H | F |
| | B | 4 | 4 | | | | | A | A | D | H |
| MAPR = 2 | C | 6 | 2 | | | | | | | A | D |
| | D | 5 | 3 | | | | | | A | B | C |
| NTPD = 1 | E | 8 | 0 | | | | | | | | |
| | F | 7 | 1 | | | | | | | | A |
| | G | 8 | 0 | | | | | | | | |
| | H | 6 | 2 | | | | | | | A | B |
| TOTALS: | 8 | 46 | 18 | | | AvB | AvD | AvB | AvC | AvH | AvF |
| | | | | | | | | | BvD | | BvH |
| | | | | | | | | | | | CvD |

Logic Step 1:

| UNIQUE | DUPLICATE |
|---|---|
| AvB, AvD, AvC, AvH, AvF BvH, BvD, | AvB |
| | CvD |

PIECE OF CAKE!!!
5) Make sure that neither the NTPD nor the team playing more than once in the same cycle rules are violated. In League1, the NTPD is broken with E vs F playing three times and in League2 both rules are broken.
6) “Fix” with the Gain/Lose logic but different rules. Simply gain/lose the match ups that are a problem until the NTPD and the team playing more than once in the same cycle are in line. The changes along with the gain/lose table are shown on the following page. Note, the gain/lose for League2 should have been done by changing the third EF to BF and switch B and E at *2. Long explanation, but basically caught my mistake later and did not want to change everything.
7) At this point, we can plug in to the above templates already scheduled games (first games, maybe other match ups):
8) Both changes are shown on the following page.

League1, First games:
A vs B, Saturday August 26^{th} 6:00
C vs D, Friday August 25^{th} 6:15
E vs F, Friday August 25^{th} 7:05

League2, 35PCC: First games:
A vs B, Saturday August 26^{th} 6:55
C vs D, Friday August 25^{th} 7:55
E vs F, Friday August 25^{th} 8:45

League3, 35PCC: First games:
A vs B, Saturday August 26^{th} 7:40
C vs D, Friday August 25^{th} 9:45
E vs F, Friday August 25^{th} 10:35
G vs H, Friday August 25^{th} 11:35

Up to this point, teams should be able to be defined simply by the primary field only (not letters). At this point, convert or add the appropriate letter. EXAMPLE League1: Team 3474 becomes team A, Team 3471 becomes team B, etc. and they are matched up for Saturday August 26^{th}, 6 PM, and that slot is removed from available slots.

We are now have a complete master template and are ready to schedule. Before we do that, however, we will back up a bit and do the crossover game logic to ensure it is compatible with

### Crossover Game Logic

First, a quick explanation of why want/need crossovers. Three reasons.
1) Two leagues with a small number of teams (4 or 5) which creates a high MAPR.
2) Two leagues with odd numbers (5 and 7) where crossover games would take a bye out of each league.
3) Selected crossover games of secondary teams reduce number of games that other teams need to play on secondary day of play when they would prefer not to.

The above scenarios create two “types” of crossover possibilities. #1 above may require a splitting of two teams playing in their normal templates to play each other; # 2 has bye teams only playing; #3 may be either. The logic may be the same, may be different. We shall see with our examples. Either way, the objective should be to create matrixes and templates compatible with as much, if not all, of the prior logic.

We will work with four examples:
1) A 5 team and 7 team league, 9 games, crossover games each week so that neither has a bye (#2 above).
2) Two 6 team brackets with crossovers to accomplish #3 above.
3)

We will start with an example of #2 above (bye teams playing).

To review the steps we have created thus far for an LG without crossover games:
1) Create the secondary matrix which creates the secondary match ups.
2) Create the secondary template.
3) Pull down the standard “x” team template of unique games and integrate with secondary template from step #2 to start to create the master template.
4) Fill in the duplicate side of the ledger around secondary games and/or complete the empty cycles to play with duplicate series of match ups (master template now complete).
5) Check all rules (NTPD)
6) Proceed to scheduling

Step 1 and 2 above are nearly identical for crossover games with the logic outlined below (LOGIC EX 2):
1) Pick the two teams from both leagues with the highest and match them up.
2) Proceed with prior logic until those two teams have played all teams in their league once.
3) Repeat step one.
4) Repeat step 2 until complete

We now have two (or three??) working primary/secondary matrixes with match ups. They are found on the following page along with all league data.

| | MASTER EXAMPLE CROSSOVER | | |
|---|---|---|---|
| Teams LG1 (35PCA) by count: | 5 | | |
| Number games per session | 9 | INPUT now or earlier with league | |
| Tourney: | NO | Ditto | See Example 2 for handling tourney |

| Crossover Games: | | YES | w/35PCC | TEAM | PRI*1 | SEC*1 | GAMES |
|---|---|---|---|---|---|---|---|
| CODE CALCULATES: | | | | 1 | 0 | 9 | 9 |
| Total Num games: | 22.5 | 22.5 | *1 | 2 | 7 | 2 | 9 |
| Unique Games | 10 | | | 3 | 7 | 2 | 9 |
| Dup Games | 12.5 | | | 4 | 7 | 2 | 9 |
| Primary Games | 14.5 | | | 5 | 8 | 1 | 9 |

| | | | | | | |
|---|---|---|---|---|---|---|
| Secondary games | 8 | TOTALS: | 5 | 29 | 16 | 45 |
| NTPD* | 5 | | | | | |
| MAPR* | 3 | | | | | |

| | | |
|---|---|---|
| MIPR* | 2 | Over ride YES/NO YES = 1 Override only if crossover = YES |

*1 Allow decimals? YES if crossover, but if derived from matrix, works either way!!

| Teams LG2 (35PCC) by count: | 7 | | | | | |
|---|---|---|---|---|---|---|
| Number games per session | 9 | INPUT now or earlier with league | | | | |
| Tourney: | NO | Ditto | TEAM | PRI | SEC | GAMES |
| Crossover Games: | YES | With 35PCN | 1 | 0 | 9 | 9 |

| CODE CALCULATES: | | | 2 | 7 | 2 | 9 |
|---|---|---|---|---|---|---|
| Total Num games: | 31.5 | | 3 | 8 | 1 | 9 |
| Unique Games | 21 | | 4 | 7 | 2 | 9 |
| Dup Games | 10.5 | | 4 | 8 | 1 | 9 |
| Primary Games | 22.5 | | 6 | 7 | 2 | 9 |
| Secondary games | 9 | | 7 | 8 | 1 | 9 |
| NTPD* | 3 | TOTALS: | 7 | 45 | 18 | 63 |
| MAPR* | 2 | | | | | |

| | | | |
|---|---|---|---|
| MIPR* | 1 | Over ride | YES/NO NO |

| | |
|---|---|
| League Checks: | GRAND TOTALS: |

| | | |
|---|---|---|
| 1) Team Pri + Sec = Total Games | Total Num games: | 54 |
| 2) Total Pri and total Sec must be even number | Unique Games | 31 |
| 3) Pri + Sec and Unique + Dup equals Total | Dup Games | 23 |
| | Primary Games | 37 |
| | Secondary games | 17 |
| CROSSOVER COMBINED | | |

| Teams LG1 (35PCA, 35PCC) by | 7 | 5 = 12 | |
|---|---|---|---|
| Number games per session | 9 | INPUT now or earlier with league | |
| Tourney: | NO | Ditto | See Example 2 for handling tourney |

| Crossover Games: | | YES | w/35PCC | | TEAM | PRI*1 | SEC*1 | GAMES |
|---|---|---|---|---|---|---|---|---|
| CODE CALCULATES: | | | | | 1 | 0 | 9 | 9 |
| Total Num games: | 54 | 54 | *1 | | 2 | 7 | 2 | 9 |
| Unique Games | 31 | | | | 3 | 7 | 2 | 9 |
| Dup Games | 23 | | | | 4 | 7 | 2 | 9 |
| Primary Games | 37 | | | | 5 | 8 | 1 | 9 |
| Secondary games | 17 | | | | 6 | 0 | 9 | 9 |
| NTPD* | 3 | NA | | | 7 | 7 | 2 | 9 |
| MAPR* | 2 | NA | | | 8 | 8 | 1 | 9 |
| MIPR* | 1 | NA | | | 9 | 7 | 2 | 9 |
| | | | | | 10 | 8 | 1 | 9 |
| | | | | | 11 | 7 | 2 | 9 |
| | | | | | 12 | 8 | 1 | 9 |
| | | | | TOTALS: | 12 | 74 | 34 | 108 |

I don't think this combined table/matrix shows me anything new or gives me anything I need.
Everything is contained in the primary/secondary matrixes and individual leagues.
I think we will need some of the games per cycle calculations though.

| | NUM | NUM | | TOTAL | | UNIQUE | | | | | | | | |
|---|---|---|---|---|---|---|---|---|---|---|---|---|---|---|
| | TEAMS | GAMES | EPC | GAMES* | CTC | GAMES | UNC | FACT | TG's | NTPD | MAPR | MIPR | XMAPR* | XMIPR* |
| WITHOUT | 5 | 9 | 2 | 22.5 | 12 | 10 | 5 | 11.25 | 0.5 | 5 | 3 | 2 | 1 | 0 |
| CROSS- | 7 | 9 | 3 | 31.5 | 11 | 21 | 7 | 10.5 | 1.5 | 3 | 2 | 1 | 1 | 0 |
| OVER | | | | | | | | | | | | | | |
| TOTAL | | | | | | | | | | | | | | |
| WITH | 5 | 9 | 2 | 22.5 | 12 | | | 11.25 | 0.5 | 5 | 3 | 2 | 1 | 0 |
| CROSS- | 7 | 9 | 3 | 31.5 | 11 | | | 10.5 | 1.5 | 3 | 2 | 1 | 1 | 0 |
| OVER | | | | | | | | | | | | | | |
| TOTAL | 12 | 9 | 6 | 54 | 9 | | | 9 | 0 | | | | | |

By taking the bye out, reduce cycles to complete from 12 and 11 to 9, and no trailing games.
Some of these calculations will be needed for the actual scheduling logic.
*Crossover Min/Max palye rulr (user input??). Override secondary only??

| League1A: | | PRI | SEC | 9 | 8 | 7 | 6 | 5 | 4 | 3 | 2 | 1 |
|---|---|---|---|---|---|---|---|---|---|---|---|---|
| | A | 0 | 9 | A | B | C | D | E | B | C | A | D |
| MAPR = 3 | B | 7 | 2 | | | | | | | | A | A |
| | C | 7 | 2 | | | | | | | | A | A |
| | D | 7 | 2 | | | | | | | | A | A |
| | E | 8 | 1 | | | | | | | | | A |
| TOTALS: | 5 | 29 | 16 | AvA | AvB | AvC | AvD | AvE | AvB | AvC | AvA | AvD |
| WEEK: | | | | | | | | | | | | |

Bold = crossover.

| League2A: | | PRI | SEC | 9 | 8 | 7 | 6 | 5 | 4 | 3 | 2 | 1 |
|---|---|---|---|---|---|---|---|---|---|---|---|---|
| | A | 0 | 9 | A | B | C | D | E | F | G | A | B |
| MAPR = 2 | B | 7 | 2 | | | | | | | | A | A |
| | C | 8 | 1 | | | | | | | | | A |
| | D | 7 | 2 | | | | | | | | A | F |
| | E | 8 | 1 | | | | | | | | | A |
| | F | 7 | 2 | | | | | | | | A | DvF |
| | G | 8 | 1 | | | | | | | | | A |
| TOTALS: | 7 | 45 | 18 | AvA | AvB | AvC | AvD | AvE | AvF | AvG | AvA | AvB |
| | | | | | | | | | | | | DvF |
| CROSS | 12 | 74 | 34 | | | | | | | | | |

### Scheduling Logic

We now have everything in place ready to schedule. For our example, we will use the three previous leagues that we have been working with, plus the difficult 9 team league that we used in our primary/secondary “Gain/Lose” method (named 35PCA). Those leagues are outlined on the following pages. Notice, in order to not have to change any templates, we gave the program some unrealistic input data concerning time slots available (adults cannot play at 4:30 in the afternoon). We could also have simply extended the number of weeks from 11 to 13 or 14, but that is an unrealistic scheduling aspect (teams would have 4-5 byes over an 8 game session). Unrealistic input times keep the scheduling aspects real.

The first thing we need to check are any items that would require a change in our templates. In our case it would concern the 11:25 PM time slot in that I never have a team play more than one 11:25 PM game. In the event the current templates require a team to play more than one 11:25 game, user would be prompted to either:
a) Override the rule OR
b) Move a game from primary to secondary OR
c) Extend the session one more week (add input times); OR
d) Take one away for use and designate it for a tourney game.

A, C, and D would not require a template change, B does. We will now test the balancing rules.

Logic:
1) Determine the amount of 11:25's available based on input (11 weeks=11 11:25 games)
2) From the template, determine the amount of games that can be played at 11:25. Secondary games would be flagged (secondary match ups have no 11:25's as no 11:25's were put in as input). The logic here is to look at the games in a cycle, flag one match up (2 teams) as 11:25, go to next cycle, remove the teams already flagged for 11:25 and find a match up, and continue until through all cycles. We also need to make sure to check to see if all teams “eligible” for an 11:25 have been flagged. To determine eligible, any team that plays on a night where we play at 11:25 is eligible unless we override. In our examples, team A in leagues 1-3 are not eligible, in League 4 all teams are eligible unless we override. We may want (user decision) to override for Team A who plays 6 games on secondary nights. We must also flag the first 11:25 game which has already been scheduled.
3) Other things to consider:
   a. In League 4 we have 9 teams (odd number), so one will not be initially flagged (user prompted to input which team does not get one, and Team A sensible choice)
   b. In Leagues 1 and 3 one team will not get flagged (in addition to Team A) because of an even number of teams, again prompt user which team.
4) Remember, at this point we are only checking the unique games of a template, as only the secondary match ups of duplicate games are in place. If we can not flag all eligible teams, and duplicate match ups will be in the final template (Leagues 1-3) we can either A) subtract out teams flagged and then match up remaining eligible teams and add them to the template of duplicate games on the secondary side of the ledger, or B) go ahead and build are complete template now. We will see which is the way to go as we proceed.
5) If there are no duplicate games and we can not get all eligible teams flagged, we start over (un flag) with a different match up. If there are options remaining from the same set of match ups where we started, we go there, if not, to the next group of set of match ups. If we go through all possibilities and still cannot get all eligible teams flagged, we go back and build a new template (use the Gain/Lose method with different secondary match ups driving the new template). This is identical process Examples A-C pages 18-27. I don't foresee having to do this, but it will work.
6) Right now are only checking to see if we can match up flagged 11:25 match ups with 11:25 slots available. However, we will use the actual match ups flagged as 11:25 games (I THINK, WE WILL SEE!!). Also, no dates have been assigned to those 11:25 games except the one already scheduled.
7) In our example, we have eleven 11:25 slots to use, and have flagged twelve 11:25 match ups. Rather than un-flag a match up, we will leave it at 12 as this will give us more flexibility as we proceed to schedule.
8) In the event we short an 11:25 slot the user would be prompted to take a course of action:
   a. Override the rule and have a team(s) play more than one 11:25 game (unlikely as we lose customers that way)
   b. move a game from primary to secondary (requires new template and which we go back and create and repeat all steps from that point). This assumes a secondary slot is available. If no slots available (now have more games that slots) and user does not want to use option a, c, or d, the code would proceed to schedule and simply not schedule one game that user would schedule manually, on a third day (Tuesday for example).
   c. Extend the session one more week (add input times) which is undesirable from the facility end.
   d. Take one 11:25 slot out of available slots and designate it for a tourney game. This will get done if teams playing have tourneys. How decide which time slot to take out of the mix?? It will be one of the two at end but might be a tough one).

We now have the following on our template: All unique games, all secondary games (unique and duplicate), remaining duplicate games filled in, with 11:25 unique games flagged. This is a temporary 11:25 flag only as we will not use these match up for our actual 11:25 games. The primary purpose is to make sure we do not have to change our template. Where forced, also on the template are match ups at 11:25 on the duplicate side of the ledger. What happens is by putting any given match up at 11:25 with any given secondary game, you begin to put built in restrictions on your scheduling.
9) If anything ever does not work, we simply go in reverse order, change, and try again: that order is:
   a. Change 11:25 pairings and try again.
   b. Change duplicate match ups and try again
   c. Build new template and try again.
   d. This last step will require some “Shuffle Rules” as there are many ways to change things. If we get in trouble with one league, do we try just that league first? The good part is there are many combinations of changes we can make. Within each league alone, just by changing the template using Gain/Lose, we have many templates at our disposal. Within the LG, we can change this league, but not that league, change these two, but not this one, etc.

We now have a complete master template that has all games for all teams, first games scheduled with dates and times, and all secondary and 11:25 games flagged (albeit temporary). Again, the main reason we do the 11:25 (or any user input) now, is to see if we have to come up with a new template. No other scheduling rules carry that much weight.

Next step I will call BYE LOGIC.

### Bye Logic

OBJECTIVE: To change our master template into what I will call our Schedule Template. The number of sets of games on our master template matches our calculated Cycles to Complete. For example, Our master template for League4 (9 teams, 8 games) has a cycles to complete of 9. Playing one cycle per week over 9 weeks will complete the schedule. However, do to business considerations, we may want to have more teams (which results in more games) playing in an LG than can finish in the normal time. Basically, we steal some time slots away and give to other LG's and add those time slots back in at the tail end. Our schedule template will have as many cycles as the length of our session, which is a function of time slots needed to time slots available. In our example, based on time slots available, that is 11 weeks or eleven cycles. Again, some familiarity with scheduling will shorten the guessing game but it will not be a long process either way. The following table will give some insight to what we need to do:

| SCH | GAMES | PRIM | SEC. | BYES | LEAGUE |
|---|---|---|---|---|---|
| CYCLE | WEEK | AVAIL | AVAIL. | NEED | W/BYE |
| 1 | 14 | 8 | 4 | 2 | |
| 2 | 14 | 8 | 4 | 2 | |
| 3 | 14 | 8 | 4 | 2 | |
| 4 | 14 | 8 | 4 | 2 | |
| 5 | 14 | 8 | 4 | 2 | |
| 6 | 14 | 8 | 4 | 2 | |
| 7 | 14 | 9 | 3 | 2 | |
| 8 | 14 | 8 | 4 | 2 | |
| 9 | 14 | 8 | 4 | 2 | |
| 10 | 14 | 8 | 4 | 2 | |
| 11 | 14 | 8 | 0 | 6 | |
| TOTAL | | 89 | 39 | | |
| | | | 128 | | |

Logic:
1) In our example, we need two byes per week to make things work. The idea is again to balance the byes, here very easy. There will be LG's where from cycle to cycle the number of byes is not the same (fluctuates cycle to cycle). We also need a pecking order of rules of which time slots to be left blank. The rule at the top of this list will be to average the byes per week over the league group; thus the extra time slot is taken away in schedule cycle 7 where we have the extra primary slot. In this case it will be a specific date (because we input that 9^{th} slot as a date). In the case of no byes, we will come up with the rules to follow.
2) To determine which league gets the bye from here out, look at the tables pages ______. The very first table on the left is before any games get played. The league (and teams within the league) that have the lowest bye ratio are the leagues that should be tabbed for the next bye (need to look at the table labeled Cycle 1. The lowest two numbers (that's how many byes we need) dictate who gets the bye in Cycle 2. At this point weare going back and forth from our matrix to these cycle by cycle tables.
3) Those two leagues are League______ and Leagues ______, and so on. Rules for byes:
   a. Keep balance of secondary and 11:25 games (don't give byes to two 11:25 match ups in different cycles, as they may end up in the same cycle; FROM PRIOR NOTES, this may not need to be done).
   b. After a given match up is selected for a bye (and we will probably have to input the first bye manually so the code can keep track of its template), it will get placed in the open spot in an array that now is expanded from the calculated cycles to “Scheduled Cycles to Complete”. In League1 (6 teams, 8 games), standard cycles is 8, scheduled cycles now 11. The maximum slots in the array is the same as the games per week (in L1=3). The next bye is selected from the next series in our master template by looking at the match ups, comparing it to our new array, and selecting a match up with no conflicts.
   c. When the first cycle of the new array is full (cycle 9, 3 match ups) we create a new cycle until we reach the number 11 above.
   d. If a given league is in line for a bye, and we can not fill each cycle based on match ups in the master template, we can go to the new array and find one that works (see League1 cycle 7).

A few things. Remember, we are only creating match ups in cycles that work for the big picture. No dates and times yet; we may not even keep the 11:25's penciled in earlier. Also, do we have a way of calculating if a given leagues cycles to schedule can be reduced to lower byes (L1, 6 teams, 8 games, 11 cycles=3 byes)???? I know it works from experience and common sense, so I proceeded to do so, changing the cycles to complete from 11 to 10 for League 1. Need to find the math approach to check ahead of time and prompt user if they want L1 (or L4) to finish in 10 weeks (2 byes) verses 11 weeks (3 byes).

From this process we are able to determine who has a bye in which cycle. The following new templates found on the following two pages are created which have the number of scheduled cycles verses mathematical calculation.

| CYCLE 2 | | GAME | GAME | SCHE [symbol] | BYE | | CYCLE 3 | | GAME | GAME | SCHE [symbol] | BYE | |
|---|---|---|---|---|---|---|---|---|---|---|---|---|---|
| BYE | TEAM | REM | WEEK | CYCL [symbol] | RATIO | | BYE | TEAM | REM | WEEK | CYCL [symbol] | RATIO | |
| L1 | | | | COMPLETE | | | L1 | | | | COMPLETE | | |
| 1 | 1 | 7 | 3 | 8 | 0.875 | | | 1 | 6 | 3 | 7 | 0.8571 | |
| | 2 | 6 | 3 | 8 | 0.75 | | | 2 | 5 | 3 | 7 | 0.7143 | |
| 1 | 3 | 7 | 3 | 8 | 0.875 | | | 3 | 6 | 3 | 7 | 0.8571 | |
| | 4 | 6 | 3 | 8 | 0.75 | | 1 | 4 | 6 | 3 | 7 | 0.8571 | |
| | 5 | 6 | 3 | 8 | 0.75 | | 1 | 5 | 6 | 3 | 7 | 0.8571 | |
| | 6 | 6 | 3 | 8 | 0.75 | | | 6 | 5 | 3 | 7 | 0.7143 | |
| TOTAL | 6 | 19 | | | 0.7917 | AVG | TOTAL | 6 | 17 | | | 0.8095 | AVG |
| League2 | | | | | | | League2 | | | | | | |
| | 1 | 7 | 3 | 9 | 0.7778 | | | 1 | 6 | 3 | 8 | 0.75 | |
| | 2 | 7 | 3 | 9 | 0.7778 | | | 2 | 6 | 3 | 8 | 0.75 | |
| | 3 | 7 | 3 | 9 | 0.7778 | | | 3 | 6 | 3 | 8 | 0.75 | |
| | 4 | 7 | 3 | 9 | 0.7778 | | | 4 | 6 | 3 | 8 | 0.75 | |
| 1 | 5 | 9 | 3 | 9 | 1 | | | 5 | 8 | 3 | 8 | 1 | |
| | 6 | 7 | 3 | 9 | 0.7778 | | 1 | 6 | 7 | 3 | 8 | 0.875 | |
| | 7 | 8 | 3 | 9 | 0.8889 | | | 7 | 7 | 3 | 8 | 0.875 | |
| TOTAL | 7 | 26 | | | 0.8254 | AVG | TOTAL | 7 | 23 | | | 0.8214 | AVG |
| League3 | | | | | | | League3 | | | | | | |
| | 1 | 7 | 4 | 9 | 0.7778 | | | 1 | 6 | 4 | 8 | 0.75 | |
| | 2 | 7 | 4 | 9 | 0.7778 | | | 2 | 6 | 4 | 8 | 0.75 | |
| | 3 | 7 | 4 | 9 | 0.7778 | | | 3 | 6 | 4 | 8 | 0.75 | |
| | 4 | 7 | 4 | 9 | 0.7778 | | | 4 | 6 | 4 | 8 | 0.75 | |
| | 5 | 8 | 4 | 9 | 0.8889 | | | 5 | 7 | 4 | 8 | 0.875 | |
| | 6 | 8 | 4 | 9 | 0.8889 | | | 6 | 7 | 4 | 8 | 0.875 | |
| | 7 | 7 | 4 | 9 | 0.7778 | | | 7 | 6 | 4 | 8 | 0.75 | |
| | 8 | 7 | 4 | 9 | 0.7778 | | | 8 | 6 | 4 | 8 | 0.75 | |
| TOTAL | 8 | 29 | | | 0.8056 | AVG | TOTAL | 8 | 25 | | | 0.7813 | AVG |
| League4 | | | | | | | League4 | | | | | | |
| 1 | 1 | 7 | 4 | 9 | 0.7778 | | | 1 | 6 | 4 | 8 | 0.75 | |
| | 2 | 6 | 4 | 9 | 0.6667 | | | 2 | 5 | 4 | 8 | 0.625 | |
| | 3 | 7 | 4 | 9 | 0.7778 | | | 3 | 6 | 4 | 8 | 0.75 | |
| | 4 | 7 | 4 | 9 | 0.7778 | | 1 | 4 | 7 | 4 | 8 | 0.875 | |
| 1 | 5 | 7 | 4 | 9 | 0.7778 | | | 5 | 6 | 4 | 8 | 0.75 | |
| | 6 | 6 | 4 | 9 | 0.6667 | | 1 | 6 | 6 | 4 | 8 | 0.75 | |
| | 7 | 6 | 4 | 9 | 0.6667 | | | 7 | 5 | 4 | 8 | 0.625 | |
| 1 | 8 | 7 | 4 | 9 | 0.7778 | | 1 | 8 | 7 | 4 | 8 | 0.875 | |
| | 9 | 7 | 4 | 9 | 0.7778 | | | 9 | 6 | 4 | 8 | 0.75 | |
| TOTAL | 9 | 30 | | | 0.7407 | AVG | TOTAL | 9 | 27 | | | 0.75 | AVG |
| GR TO [symbol] | 30 | 104 | | | | | GR TO [symbol] | 30 | 92 | | | | |
| GAMES PLAYED CYCLE 1: | | | | 12 | | | GAMES PLAYED CYCLE 1: | | | | 12 | | |
| CYCLE 4 | | GAME | GAME | SCHE [symbol] | BYE | | CYCLE 5 | | GAME | GAME | SCHE [symbol] | BYE | |
| BYE | TEAM | REM | WEEK | CYCL [symbol] | RATIO | | BYE | TEAM | REM | WEEK | CYCL [symbol] | RATIO | |
| L1 | | | | COMPLETE | | | L1 | | | | COMPLETE | | |
| | 1 | 5 | 3 | 6 | 0.8333 | | | 1 | 4 | 3 | 5 | 0.8 | |
| | 2 | 4 | 3 | 6 | 0.6667 | | 1 | 2 | 4 | 3 | 5 | 0.8 | |
| | 3 | 5 | 3 | 6 | 0.8333 | | | 3 | 4 | 3 | 5 | 0.8 | |
| | 4 | 5 | 3 | 6 | 0.8333 | | | 4 | 4 | 3 | 5 | 0.8 | |
| | 5 | 5 | 3 | 6 | 0.8333 | | | 5 | 4 | 3 | 5 | 0.8 | |
| | 6 | 4 | 3 | 6 | 0.6667 | | 1 | 6 | 4 | 3 | 5 | 0.8 | |
| TOTAL | 6 | 14 | | | 0.7778 | AVG | TOTAL | 6 | 12 | | | 0.8 | AVG |
| League2 | | | | | | | League2 | | | | | | |
| 1 | 1 | 6 | 3 | 7 | 0.8571 | | | 1 | 5 | 3 | 6 | 0.8333 | |
| | 2 | 5 | 3 | 7 | 0.7143 | | 1 | 2 | 5 | 3 | 6 | 0.8333 | |
| | 3 | 5 | 3 | 7 | 0.7143 | | | 3 | 4 | 3 | 6 | 0.6667 | |
| | 4 | 5 | 3 | 7 | 0.7143 | | | 4 | 4 | 3 | 6 | 0.6667 | |
| | 5 | 7 | 3 | 7 | 1 | | | 5 | 6 | 3 | 6 | 1 | |
| | 6 | 6 | 3 | 7 | 0.8571 | | | 6 | 5 | 3 | 6 | 0.8333 | |
| | 7 | 6 | 3 | 7 | 0.8571 | | | 7 | 5 | 3 | 6 | 0.8333 | |
| TOTAL | 7 | 20 | | | 0.8163 | AVG | TOTAL | 7 | 17 | | | 0.8095 | AVG |
| League3 | | | | | | | League3 | | | | | | |
| 1 | 1 | 6 | 4 | 7 | 0.8571 | | | 1 | 5 | 4 | 6 | 0.8333 | |
| | 2 | 5 | 4 | 7 | 0.7143 | | | 2 | 4 | 4 | 6 | 0.6667 | |
| | 3 | 5 | 4 | 7 | 0.7143 | | | 3 | 4 | 4 | 6 | 0.6667 | |
| | 4 | 5 | 4 | 7 | 0.7143 | | | 4 | 4 | 4 | 6 | 0.6667 | |
| | 5 | 6 | 4 | 7 | 0.8571 | | | 5 | 5 | 4 | 6 | 0.8333 | |
| | 6 | 6 | 4 | 7 | 0.8571 | | | 6 | 5 | 4 | 6 | 0.8333 | |
| | 7 | 5 | 4 | 7 | 0.7143 | | | 7 | 4 | 4 | 6 | 0.6667 | |
| 1 | 8 | 6 | 4 | 7 | 0.8571 | | | 8 | 5 | 4 | 6 | 0.8333 | |
| TOTAL | 8 | 22 | | | 0.7857 | AVG | TOTAL | 8 | 18 | | | 0.75 | AVG |
| League4 | | | | | | | League4 | | | | | | |
| | 1 | 5 | 4 | 7 | 0.7143 | | 1 | 1 | 5 | 4 | 6 | 0.8333 | |
| 1 | 2 | 5 | 4 | 7 | 0.7143 | | | 2 | 4 | 4 | 6 | 0.6667 | |
| 1 | 3 | 6 | 4 | 7 | 0.8571 | | | 3 | 5 | 4 | 6 | 0.8333 | |
| | 4 | 6 | 4 | 7 | 0.8571 | | 1 | 4 | 6 | 4 | 6 | 1 | |
| | 5 | 5 | 4 | 7 | 0.7143 | | 1 | 5 | 5 | 4 | 6 | 0.8333 | |
| | 6 | 5 | 4 | 7 | 0.7143 | | | 6 | 4 | 4 | 6 | 0.6667 | |
| 1 | 7 | 5 | 4 | 7 | 0.7143 | | | 7 | 4 | 4 | 6 | 0.6667 | |
| | 8 | 6 | 4 | 7 | 0.8571 | | | 8 | 5 | 4 | 6 | 0.8333 | |
| | 9 | 5 | 4 | 7 | 0.7143 | | | 9 | 4 | 4 | 6 | 0.6667 | |
| TOTAL | 9 | 24 | | | 0.7619 | AVG | TOTAL | 9 | 21 | | | 0.7778 | AVG |
| GR TO [symbol] | 30 | 80 | | | | | GR TO [symbol] | 30 | 68 | | | | |
| GAMES PLAYED CYCLE 1: | | | | 12 | | | GAMES PLAYED CYCLE 1: | | | | 12 | | |
| CYCLE 6 | | GAME | GAME | SCHE [symbol] | BYE | | CYCLE 7 | | GAME | GAME | SCHE [symbol] | BYE | |
| BYE | TEAM | REM | WEEK | CYCL [symbol] | RATIO | | BYE | TEAM | REM | WEEK | CYCL [symbol] | RATIO | |
| L1 | | | | COMPLETE | | | L1 | | | | COMPLETE | | |
| | 1 | 3 | 3 | 4 | 0.75 | | 1 | 1 | 3 | 3 | 3 | 1 | |
| | 2 | 3 | 3 | 4 | 0.75 | | 1 | 2 | 3 | 3 | 3 | 1 | |
| | 3 | 3 | 3 | 4 | 0.75 | | | 3 | 2 | 3 | 3 | 0.6667 | |
| | 4 | 3 | 3 | 4 | 0.75 | | | 4 | 2 | 3 | 3 | 0.6667 | |
| | 5 | 3 | 3 | 4 | 0.75 | | | 5 | 2 | 3 | 3 | 0.6667 | |
| | 6 | 3 | 3 | 4 | 0.75 | | | 6 | 2 | 3 | 3 | 0.6667 | |
| TOTAL | 6 | 9 | | | 0.75 | AVG | TOTAL | 6 | 7 | | | 0.7778 | AVG |
| League2 | | | | | | | League2 | | | | | | |
| | 1 | 4 | 3 | 5 | 0.8 | | | 1 | 3 | 3 | 4 | 0.75 | |
| | 2 | 4 | 3 | 5 | 0.8 | | | 2 | 3 | 3 | 4 | 0.75 | |
| | 3 | 3 | 3 | 5 | 0.6 | | 1 | 3 | 3 | 3 | 4 | 0.75 | |
| 1 | 4 | 4 | 3 | 5 | 0.8 | | | 4 | 3 | 3 | 4 | 0.75 | |
| | 5 | 5 | 3 | 5 | 1 | | | 5 | 4 | 3 | 4 | 1 | |
| | 6 | 4 | 3 | 5 | 0.8 | | | 6 | 3 | 3 | 4 | 0.75 | |
| | 7 | 4 | 3 | 5 | 0.8 | | | 7 | 3 | 3 | 4 | 0.75 | |
| TOTAL | 7 | 14 | | | 0.8 | AVG | TOTAL | 7 | 11 | | | 0.7857 | AVG |
| League3 | | | | | | | League3 | | | | | | |
| | 1 | 4 | 4 | 5 | 0.8 | | | 1 | 3 | 4 | 4 | 0.75 | |
| | 2 | 3 | 4 | 5 | 0.6 | | 1 | 2 | 3 | 4 | 4 | 0.75 | |
| 1 | 3 | 4 | 4 | 5 | 0.8 | | | 3 | 3 | 4 | 4 | 0.75 | |
| | 4 | 3 | 4 | 5 | 0.6 | | 1 | 4 | 3 | 4 | 4 | 0.75 | |
| | 5 | 4 | 4 | 5 | 0.8 | | | 5 | 3 | 4 | 4 | 0.75 | |
| | 6 | 4 | 4 | 5 | 0.8 | | | 6 | 3 | 4 | 4 | 0.75 | |
| 1 | 7 | 4 | 4 | 5 | 0.8 | | | 7 | 3 | 4 | 4 | 0.75 | |
| | 8 | 4 | 4 | 5 | 0.8 | | | 8 | 3 | 4 | 4 | 0.75 | |
| TOTAL | 8 | 15 | | | 0.75 | AVG | TOTAL | 8 | 12 | | | 0.75 | AVG |
| League4 | | | | | | | League4 | | | | | | |
| | 1 | 4 | 4 | 5 | 0.8 | | | 1 | 3 | 4 | 4 | 0.75 | |
| | 2 | 3 | 4 | 5 | 0.6 | | | 2 | 2 | 4 | 4 | 0.5 | |
| | 3 | 4 | 4 | 5 | 0.8 | | | 3 | 3 | 4 | 4 | 0.75 | |
| | 4 | 5 | 4 | 5 | 1 | | | 4 | 4 | 4 | 4 | 1 | |
| | 5 | 4 | 4 | 5 | 0.8 | | | 5 | 3 | 4 | 4 | 0.75 | |
| | 6 | 3 | 4 | 5 | 0.6 | | 1 | 6 | 3 | 4 | 4 | 0.75 | |
| 1 | 7 | 4 | 4 | 5 | 0.8 | | | 7 | 3 | 4 | 4 | 0.75 | |
| 1 | 8 | 5 | 4 | 5 | 1 | | | 8 | 4 | 4 | 4 | 1 | |
| 1 | 9 | 4 | 4 | 5 | 0.8 | | | 9 | 3 | 4 | 4 | 0.75 | |
| TOTAL | 9 | 18 | | | 0.8 | AVG | TOTAL | 9 | 14 | | | 0.7778 | AVG |
| GR TO [symbol] | 30 | 56 | | | | | GR TO [symbol] | 30 | 44 | | | | |
| GAMES PLAYED CYCLE 1: | | | | 12 | | | GAMES PLAYED CYCLE 1: | | | | 12 | | |
| CYCLE 8 | | GAME | GAME | SCHE [symbol] | BYE | | CYCLE 9 | | GAME | GAME | SCHE [symbol] | BYE | |
| BYE | TEAM | REM | WEEK | CYCL [symbol] | RATIO | | BYE | TEAM | REM | WEEK | CYCL [symbol] | RATIO | |
| L1 | | | | COMPLETE | | | L1 | | | | COMPLETE | | |
| | 1 | 2 | 3 | 2 | 1 | | | 1 | 1 | 3 | 1 | 1 | |
| | 2 | 2 | 3 | 2 | 1 | | | 2 | 1 | 3 | 1 | 1 | |
| | 3 | 1 | 3 | 2 | 0.5 | | | 3 | 0 | 3 | 1 | 0 | |
| | 4 | 1 | 3 | 2 | 0.5 | | 1 | 4 | 1 | 3 | 1 | 1 | |
| | 5 | 1 | 3 | 2 | 0.5 | | 1 | 5 | 0 | 3 | 1 | 0 | |
| | 6 | 1 | 3 | 2 | 0.5 | | | 6 | 0 | 3 | 1 | 0 | |
| TOTAL | 6 | 4 | | | 0.6667 | AVG | TOTAL | 6 | 2 | | | 0.6667 | AVG |
| League2 | | | | | | | League2 | | | | | | |
| | 1 | 2 | 3 | 3 | 0.6667 | | | 1 | 1 | 3 | 2 | 0.5 | |
| | 2 | 2 | 3 | 3 | 0.6667 | | 1 | 2 | 2 | 3 | 2 | 1 | |
| | 3 | 2 | 3 | 3 | 0.6667 | | | 3 | 1 | 3 | 2 | 0.5 | |
| | 4 | 2 | 3 | 3 | 0.6667 | | | 4 | 1 | 3 | 2 | 0.5 | |
| | 5 | 3 | 3 | 3 | 1 | | | 5 | 2 | 3 | 2 | 1 | |
| | 6 | 2 | 3 | 3 | 0.6667 | | | 6 | 1 | 3 | 2 | 0.5 | |
| 1 | 7 | 3 | 3 | 3 | 1 | | | 7 | 2 | 3 | 2 | 1 | |
| TOTAL | 7 | 8 | | | 0.7619 | AVG | TOTAL | 7 | 5 | | | 0.7143 | AVG |
| League3 | | | | | | | League3 | | | | | | |
| | 1 | 2 | 4 | 3 | 0.6667 | | | 1 | 1 | 4 | 2 | 0.5 | |
| 1 | 2 | 3 | 4 | 3 | 1 | | | 2 | 2 | 4 | 2 | 1 | |
| | 3 | 2 | 4 | 3 | 0.6667 | | 1 | 3 | 2 | 4 | 2 | 1 | |
| | 4 | 2 | 4 | 3 | 0.6667 | | 1 | 4 | 2 | 4 | 2 | 1 | |
| 1 | 5 | 3 | 4 | 3 | 1 | | | 5 | 2 | 4 | 2 | 1 | |
| | 6 | 2 | 4 | 3 | 0.6667 | | | 6 | 1 | 4 | 2 | 0.5 | |
| | 7 | 2 | 4 | 3 | 0.6667 | | | 7 | 1 | 4 | 2 | 0.5 | |
| | 8 | 2 | 4 | 3 | 0.6667 | | | 8 | 1 | 4 | 2 | 0.5 | |
| TOTAL | 8 | 9 | | | 0.75 | AVG | TOTAL | 8 | 6 | | | 0.75 | AVG |
| League4 | | | | | | | League4 | | | | | | |
| | 1 | 2 | 4 | 3 | 0.6667 | | 1 | 1 | 2 | 4 | 2 | 1 | |
| 1 | 2 | 2 | 4 | 3 | 0.6667 | | | 2 | 1 | 4 | 2 | 0.5 | |
| | 3 | 2 | 4 | 3 | 0.6667 | | | 3 | 1 | 4 | 2 | 0.5 | |
| | 4 | 3 | 4 | 3 | 1 | | | 4 | 2 | 4 | 2 | 1 | |
| 1 | 5 | 3 | 4 | 3 | 1 | | | 5 | 2 | 4 | 2 | 1 | |
| | 6 | 2 | 4 | 3 | 0.6667 | | | 6 | 1 | 4 | 2 | 0.5 | |
| 1 | 7 | 3 | 4 | 3 | 1 | | | 7 | 2 | 4 | 2 | 1 | |
| | 8 | 3 | 4 | 3 | 1 | | | 8 | 2 | 4 | 2 | 1 | |
| | 9 | 2 | 4 | 3 | 0.6667 | | | 9 | 1 | 4 | 2 | 0.5 | |
| TOTAL | 9 | 11 | | | 0.8148 | AVG | TOTAL | 9 | 7 | | | 0.7778 | AVG |
| GR TO [symbol] | 30 | 32 | | | | | GR TO [symbol] | 30 | 20 | | | | |
| GAMES PLAYED CYCLE 1: | | | | 12 | | | GAMES PLAYED CYCLE 1: | | | | 12 | | |
| CYCLE 10 | | GAME | GAME | SCHE [symbol] | BYE | | CYCLE 11 | | GAME | GAME | SCHE [symbol] | BYE | |
| BYE | TEAM | REM | WEEK | CYCL [symbol] | RATIO | | BYE | TEAM | REM | WEEK | CYCL [symbol] | RATIO | |
| L1 | | | | COMPLETE | | | L1 | | | | COMPLETE | | |
| | 1 | 0 | 3 | 0 | −1 | | | 1 | −1 | 3 | −1 | 1 | |
| | 2 | 0 | 3 | 0 | −1 | | | 2 | −1 | 3 | −1 | 1 | |
| 1 | 3 | 0 | 3 | 0 | −1 | | 1 | 3 | 0 | 3 | −1 | 0 | |
| | 4 | 0 | 3 | 0 | −1 | | | 4 | −1 | 3 | −1 | 1 | |
| | 5 | 0 | 3 | 0 | −1 | | | 5 | −1 | 3 | −1 | 1 | |
| 1 | 6 | 0 | 3 | 0 | −1 | | 1 | 6 | 0 | 3 | −1 | 0 | |
| TOTAL | 6 | 0 | | | −1 | AVG | TOTAL | 6 | −2 | | | 0.6667 | AVG |
| League2 | | | | | | | League2 | | | | | | |
| 1 | 1 | 1 | 3 | 1 | 1 | | 1 | 1 | 1 | 3 | 0 | −1 | |
| | 2 | 1 | 3 | 1 | 1 | | | 2 | 0 | 3 | 0 | −1 | |
| 1 | 3 | 1 | 3 | 1 | 1 | | 1 | 3 | 1 | 3 | 0 | −1 | |
| 1 | 4 | 1 | 3 | 1 | 1 | | 1 | 4 | 1 | 3 | 0 | −1 | |
| | 5 | 1 | 3 | 1 | 1 | | | 5 | 0 | 3 | 0 | −1 | |
| | 6 | 0 | 3 | 1 | 0 | | | 6 | −1 | 3 | 0 | −1 | |
| | 7 | 1 | 3 | 1 | 1 | | | 7 | 0 | 3 | 0 | −1 | |
| TOTAL | 7 | 3 | | | 0.8571 | AVG | TOTAL | 7 | 1 | | | −1 | AVG |
| League3 | | | | | | | League3 | | | | | | |
| | 1 | 0 | 4 | 1 | 0 | | | 1 | −1 | 4 | 0 | −1 | |
| | 2 | 1 | 4 | 1 | 1 | | | 2 | 0 | 4 | 0 | −1 | |
| | 3 | 1 | 4 | 1 | 1 | | 1 | 3 | 1 | 4 | 0 | −1 | |
| | 4 | 1 | 4 | 1 | 1 | | 1 | 4 | 1 | 4 | 0 | −1 | |
| | 5 | 1 | 4 | 1 | 1 | | 1 | 5 | 1 | 4 | 0 | −1 | |
| | 6 | 0 | 4 | 1 | 0 | | | 6 | −1 | 4 | 0 | −1 | |
| | 7 | 0 | 4 | 1 | 0 | | | 7 | −1 | 4 | 0 | −1 | |
| | 8 | 0 | 4 | 1 | 0 | | 1 | 8 | 0 | 4 | 0 | −1 | |
| TOTAL | 8 | 2 | | | 0.5 | AVG | TOTAL | 8 | 0 | | | −1 | AVG |
| League4 | | | | | | | League4 | | | | | | |
| | 1 | 1 | 4 | 1 | 1 | | | 1 | 0 | 4 | 0 | −1 | |
| | 2 | 0 | 4 | 1 | 0 | | 1 | 2 | 0 | 4 | 0 | −1 | |
| | 3 | 0 | 4 | 1 | 0 | | 1 | 3 | 0 | 4 | 0 | −1 | |
| | 4 | 1 | 4 | 1 | 1 | | 1 | 4 | 1 | 4 | 0 | −1 | |
| | 5 | 1 | 4 | 1 | 1 | | 1 | 5 | 1 | 4 | 0 | −1 | |
| | 6 | 0 | 4 | 1 | 0 | | | 6 | −1 | 4 | 0 | −1 | |
| | 7 | 1 | 4 | 1 | 1 | | 1 | 7 | 1 | 4 | 0 | −1 | |
| | 8 | 1 | 4 | 1 | 1 | | | 8 | 0 | 4 | 0 | −1 | |
| 1 | 9 | 1 | 4 | 1 | 1 | | | 9 | 0 | 4 | 0 | −1 | |
| TOTAL | 9 | 3 | | | 0.6667 | AVG | TOTAL | 9 | 1 | | | −1 | AVG |
| GR TO [symbol] | 30 | 8 | | | | | GR TO [symbol] | 30 | 0 | | | | |

| | | | |
|---|---|---|---|
| GAMES PLAYED CYCLE 1: | 12 | GAMES PLAYED CYCLE 1: | 8 |

| | | | | |
|---|---|---|---|---|
| | LEAGUE1 | | | |
| | A B | 8/26 6PM | 6 | A E |
| 1 | E F | 8/25 5:25PM | | C F |
| | C D | 8/25 6:15pm | | B D |
| 2 | B E | 11:25 | | F D |
| | D F | | 8 | C A |
| | | | | E B |
| 3 | A F | | | |
| | B C | | 10 | A B |
| | | | | D E |
| 4 | D A | | | |
| | C E | | 7 | D C |
| | B F | | | F E |
| 5 | A D | | | |
| | C E | | | |
| 9 | A C | | | |
| | B F | | | |
| | LEAGUE2 | | | E A |
| | | | 6 | F B |
| | A B | 8/26 6:55PM | | G C |
| 1 | E F | 8/25 7:05PM | | |
| | C D | 8/25 7:55PM | | F A |
| | | | 7 | E B |
| | A C | | | G D |
| 2 | D B | 11:25 | | |
| | F G | | | B A |
| | | | 8 | D C |
| | A D | | | F E |
| 3 | B C | | | |
| | E G | 11:25 | | C A |
| | | | 9 | E D |
| | B G | | | G F |
| 4 | C F | | | |
| | D E | | | A D |
| | | | 11 | B C |
| | A G | | | E G |
| 5 | C E | 11:25 | | |
| | D F | | 10 | F E |
| | | | | G B |

| | | | | | |
|---|---|---|---|---|---|
| | LEAGUE3 | | | | |
| | A B | 8/26 7:50PM | 6 | A E | |
| 1 | C D | 8/25 8:45PM | | F B | |
| | G H | 8/25 9:45PM | | H D | |
| 2 | C A | | | | |
| | B D | 11:25 | 7 | E F | |
| | F G | | | A H | |
| | E H | | | C G | |
| 3 | A D | | 9 | B A | |
| | B C | | | F E | |
| | E G | 11:25 | | H G | |
| | F H | | | | |
| | | | 10 | A C | |
| 4 | G B | | | E D | |
| | D E | | | F G | |
| | C F | | | B H | |
| | | 11:25 | | | |
| | | | 11 | B E | |
| 5 | G A | | | C D | |
| | H B | | | | |
| | E C | | 8 | D G | |
| | D F | | | A F | |
| | | | | C H | |
| | LEAGUE4 | | | | |
| | | | 6 | B F | |
| | A B | 8/26 8:40PM | | E D | 11:25 |
| 1 | E H | 8/25 10:35PM | | A C | |
| | G F | 8/25 11:25PM | | | |
| | | | 7 | H B | |
| 2 | B C | | | I D | |
| | D G | | | G A | |
| | F I | | | C E | |
| 3 | I A | | 8 | D H | |
| | B E | | | F A | |
| | C G | | | I C | |
| 4 | E I | | 9 | E F | |
| | H A | | | B D | |
| | D F | | | C H | 11:25 |
| | | | | G I | |
| 5 | H G | | | | |
| | F C | | 10 | C D | |
| | I B | 11:25 | | A E | |
| | | | | F H | |
| 11 | A D | | | B G | |
| | H I | | | | |
| | E G | | | | |

From this same information we can also put this information in the table below which compares the primary and secondary allocations of are created template to our input of primary and secondary time slots week by week. As you can see, with the cycles copies in chronological order, they do not match the input of time slots all:

| SCH | GAME | PRIM | SEC. | BYES | LEAGUE1 | | LEAGUE2 | | LEAGUE3 | | LEAGUE4 | | TOTALS | | DIFF | DIFF |
|---|---|---|---|---|---|---|---|---|---|---|---|---|---|---|---|---|
| CYCLE | WEEK | AVAIL | AVAIL | NEED | PRI | SEC | PRI | SEC | PRI | SEC | PRI | SEC | PRI | SEC | PIM* | SEC* |
| 1 | 14 | 8 | 4 | 2 | 2 | 1 | 2 | 1 | 2 | 1 | 2 | 1 | 8 | 4 | 0 | 0 |
| 2 | 14 | 8 | 4 | 2 | 2 | 0 | 2 | 1 | 3 | 1 | 3 | 0 | 10 | 2 | 2 | −2 |
| 3 | 14 | 8 | 4 | 2 | 1 | 1 | 2 | 1 | 3 | 1 | 2 | 1 | 8 | 4 | 0 | 0 |
| 4 | 14 | 8 | 4 | 2 | 2 | 1 | 3 | 0 | 3 | 0 | 2 | 1 | 10 | 2 | 2 | −2 |
| 5 | 14 | 8 | 4 | 2 | 1 | 1 | 2 | 1 | 3 | 1 | 3 | 0 | 9 | 3 | 1 | −1 |
| 6 | 14 | 8 | 4 | 2 | 2 | 1 | 2 | 1 | 2 | 1 | 2 | 1 | 8 | 4 | 0 | 0 |
| 7 | 14 | 9 | 3 | 2 | 1 | 1 | 2 | 1 | 2 | 1 | 2 | 2 | 7 | 5 | −2 | 2 |
| 8 | 14 | 8 | 4 | 2 | 2 | 1 | 2 | 1 | 2 | 1 | 2 | 1 | 8 | 4 | 0 | 0 |
| 9 | 14 | 8 | 4 | 2 | 1 | 1 | 2 | 1 | 2 | 1 | 3 | 1 | 8 | 4 | 0 | 0 |
| 10 | 14 | 8 | 4 | 2 | 1 | 1 | 1 | 1 | 2 | 2 | 3 | 1 | 7 | 5 | −1 | 1 |
| 11 | 14 | 8 | 0 | 6 | 0 | 0 | 2 | 1 | 2 | 0 | 2 | 1 | 6 | 2 | −2 | 2 |
| TOTAL | | 89 | 39 | 128 | 15 | 9 | 22 | 10 | 26 | 10 | 26 | 10 | | | | |

*A negative means need to add a game, positive subtr [symbol]
HOWEVER, IT DOES NOT MATCH THE INPUT PRIMARY AND SECONDARY BY INPUT CYCLE.
We make the following cycle switches:
1) League4: Switch cycle 2 with cycle 11.
2) League2: Switch cycle 4 with cycle 11.
3) League4: Switch cycle 5 with cycle 7.
4) League3: Switch cycle 10 with cycle 2.
5) League3: Switch cycle 7 with cycle 4.
6) League3: Switch new cycle 7 with cycle 5.
AND WE GET:

| SCH | GAME | PRIM | SEC. | BYES | LEAGUE1 | | LEAGUE2 | | LEAGUE3 | | LEAGUE4 | | TOTALS | | DIFF | DIFF |
|---|---|---|---|---|---|---|---|---|---|---|---|---|---|---|---|---|
| CYCLE | WEEK | AVAIL | AVAIL | NEED | PRI | SEC | PRI | SEC | PRI | SEC | PRI | SEC | PRI | SEC | PIM* | SEC* |
| 1 | 14 | 8 | 4 | 2 | 2 | 1 | 2 | 1 | 2 | 1 | 2 | 1 | 8 | 4 | 0 | 0 |
| 2 | 14 | 8 | 4 | 2 | 2 | 0 | 2 | 1 | 2 | 2 | 2 | 1 | 8 | 4 | 0 | 0 |
| 3 | 14 | 8 | 4 | 2 | 1 | 1 | 2 | 1 | 3 | 1 | 2 | 1 | 8 | 4 | 0 | 0 |
| 4 | 14 | 8 | 4 | 2 | 2 | 1 | 2 | 1 | 2 | 1 | 2 | 1 | 8 | 4 | 0 | 0 |
| 5 | 14 | 8 | 4 | 2 | 1 | 1 | 2 | 1 | 3 | 0 | 2 | 2 | 8 | 4 | 0 | 0 |
| 6 | 14 | 8 | 4 | 2 | 2 | 1 | 2 | 1 | 2 | 1 | 2 | 1 | 8 | 4 | 0 | 0 |
| 7 | 14 | 9 | 3 | 2 | 1 | 1 | 2 | 1 | 3 | 1 | 3 | 0 | 9 | 3 | 0 | 0 |
| 8 | 14 | 8 | 4 | 2 | 2 | 1 | 2 | 1 | 2 | 1 | 2 | 1 | 8 | 4 | 0 | 0 |
| 9 | 14 | 8 | 4 | 2 | 1 | 1 | 2 | 1 | 2 | 1 | 3 | 1 | 8 | 4 | 0 | 0 |
| 10 | 14 | 8 | 4 | 2 | 1 | 1 | 1 | 1 | 3 | 1 | 3 | 1 | 8 | 4 | 0 | 0 |
| 11 | 14 | 8 | 0 | 6 | 0 | 0 | 3 | 0 | 2 | 0 | 3 | 0 | 8 | 0 | 0 | 0 |
| TOTAL | | 89 | 39 | 128 | 15 | 9 | 22 | 10 | 26 | 10 | 26 | 10 | | | | |

We make the identical swaps on our template, and we now have a chronologically working actual scheduling template for our LG. it is found for each league and the entire LG on the following pages (72 and 73).

| | | | | |
|---|---|---|---|---|
| | LEAGUE1 | | | |
| | A B | 8/26 6PM | 6 | A E |
| 1 | E F | 8/25 5:25PM | | C F |
| | C D | 8/25 6:15pm | | B D |
| 2 | B E | 11:25 | | F D |
| | D F | | 8 | C A |
| | | | | E B |
| 3 | A F | | | |
| | B C | | 10 | A B |
| | | | | D E |
| 4 | D A | | | |
| | C E | | 7 | D C |
| | B F | | | F E |
| 5 | A D | | | |
| | C E | | | |
| 9 | A C | | | |
| | B F | | | |
| | LEAGUE2 | | | E A |
| | | | 6 | F B |
| | A B | 8/26 6:55PM | | G C |
| 1 | E F | 8/25 7:05PM | | |
| | C D | 8/25 7:55PM | | F A |
| | | | 7 | E B |
| | A C | | | G D |
| 2 | D B | 11:25 | | |
| | F G | | | B A |
| | | | 8 | D C |
| | A D | | | F E |
| 3 | B C | | | |
| | E G | 11:25 | | C A |
| | | | 9 | E D |
| | B G | | | G F |
| 11 | C F | | | |
| | D E | | | A D |
| | | | 4 | B C |
| | A G | | | E G |
| 5 | C E | 11:25 | | |
| | D F | | 10 | F E |
| | | | | G B |

| | | | | | |
|---|---|---|---|---|---|
| | LEAGUE3 | | | | |
| | A B | 8/26 7:50PM | 6 | A E | |
| 1 | C D | 8/25 8:45PM | | F B | |
| | G H | 8/25 9:45PM | | H D | |
| 10 | C A | | | | |
| | B D | 11:25 | 4 | E F | |
| | F G | | | A H | |
| | E H | | | C G | |
| 3 | A D | | 9 | B A | |
| | B C | | | F E | |
| | E G | 11:25 | | H G | |
| | F H | | | | |
| | | | 2 | A C | |
| 5 | G B | | | E D | |
| | D E | | | F G | |
| | C F | | | B H | |
| | | 11:25 | | | |
| | | | 11 | B E | |
| 7 | G A | | | C D | |
| | H B | | | | |
| | E C | | 8 | D G | |
| | D F | | | A F | |
| | | | | C H | |
| | LEAGUE4 | | | | |
| | | | 6 | B F | |
| | A B | 8/26 8:40PM | | E D | 11:25 |
| 1 | E H | 8/25 10:35PM | | A C | |
| | G F | 8/25 11:25PM | | | |
| | | | 5 | H B | |
| 11 | B C | | | I D | |
| | D G | | | G A | |
| | F I | | | C E | |
| 3 | I A | | 8 | D H | |
| | B E | | | F A | |
| | C G | | | I C | |
| 4 | E I | | 9 | E F | |
| | H A | | | B D | |
| | D F | | | C H | 11:25 |
| | | | | G I | |
| 7 | H G | | | | |
| | F C | | 10 | C D | |
| | I B | 11:25 | | A E | |
| | | | | F H | |
| 2 | A D | | | B G | |
| | H I | | | | |
| | E G | | | | |

Things to Consider/Thoughts/Ideas as Proceed:
1) Tourney formats
2) Scheduling details:
   a) Allow more than one game per cycle, Y/N (one team has bye if possible). EX: 7 team league, 8 games, have one extra game extending whole session for all, so want to play. EX: team registers late, want that team to be the one that has to double up.
   b) User request which teams(s) want to play twice (duplicate games); which teams not to play twice.
   c) Target total factor for each team based on how many primary/secondary and total factors.
3) Crossovers: not totally comfortable with logic tying in with all other logic.
4) I would like to be able to input more slots than needed, but make sure specific slots are used. In our example, I need to used only one primary slot at 4:30; I would like to input multiple 4:30 slots (verses one on a specific date), but use only one, giving the code to mix and match for the greatest flexibility and efficiency). Also, in our example, 2 of the 11 secondary time slots are different (later); I want them filled, but don't want to restrict the weeks. Can we input as follows: One week, use 9 primary slots, 10 weeks 8 primary slots, listing all 11 weeks at 4:30 as available. Second scenario: input 11 weeks with all 6 slots available (6-10:30), but only use 2 of the later set of slots.
5) If we make available more slots than needed (in our example we have 32 secondary slots available, 29 games, leaves 3 slots unused). We need to a hierarchy of rules of how to leave the slots open (user input may be needed here): late ones, early ones, not in middle of LG, at the end, etc.)
6) Allowing teams to play more than one game per cycle (trailing games only, get session over in “x” weeks, team enters late, first game scheduled, but need session over in timely fashion (standard cycles to complete)
7) How to calculate if one league within the LG can finish in one fewer cycle without pushing the LG one extra week (our example, L1 in 10 weeks).
8) Detailed/solid help messages.
9) Detailed/solid error messages.
10) Scheduling assistor?
11) Need to compile solid, detailed list of all user interfaces:
   a) Input
   b) Reports
   c) Changes once schedules out and done
12) Real time schedule monitoring. Code needs to know what slots available, which ones are not. If changes made, any rules violated? Be able to do trial runs before run the actual final schedule.
13) With duplicate games, can we pick who plays who once, who plays who twice?
14) Can we balance secondary slots with certain teams? In our example, the secondary day of play is Saturday. Saturday is some ones primary day of play. If we do the Friday/Saturday LG first, those times slots are locked out and only unlocked with a schedule change to schedules already out 9 which is not customer friendly). Can we put say U16 boys in that LG (or schedule two LG's simultaneously) and make it work? We would schedule LG1, who will take secondary time slots which are LG2's primary slots. If LG2 does not work, re-do LG1 changing input. This ties in with #4 and #15 below.
15) MAKE FLEXIBLE TO FIT INTO OTHER APPLICATIONS (leagues with multiple fields, tournaments, double elimination, etc.) If not able to fit neatly, change with as little change to code as possible.

What is currently on the market is not able to handle many of the situations that are commonplace in today's sports scheduling environment. This includes, but not limited to, teams playing on secondary days of play, crossover games between leagues, and first games already scheduled. I believe what other software programs try to do is start with a template and through math permutations, force the above conditions into a template and try to arrive at a schedule that works. I believe that what happens is that even through multiple mathematical permutations, a good working template cannot be obtained because of multiple conditions the user is trying to fit into the template.

My approach is completely different in that I create the match ups required (secondary, crossover, and first games), and then build the template around those parameters or match ups. With the match ups created before the template, and building the template to fit the match ups, the match ups required to meet the up front parameters are in place before we start any shuffling or permutations. As a result the number of permutations required are greatly reduced, if needed at all. And even when required, I create “permutations” with a very simple non-mathematical approach in what I call the Gain/Lose Method, again, starting with the required match ups already in place.

The balance of the program is probably similar to other programs out there (balancing early and late game, and rotating byes into the schedule as needed), but with a template created that already has most of the conditions in place to make it work, this is a much simpler and easier task to fulfill.

1. A method for automatically scheduling events, comprising:
determining a condition (date, time, team pairing, location preference, meeting sequence, ranking, etc.) associated with a first participant;
based on the condition, automatically determining a schedule that includes the first participant.

2. The method of claim 1, wherein the determining includes matching the first participant to a second participant.
